(19) United States
(12) Patent Application Publication
(10) Pub. No.: US 2026/0367252 A1
(43) Pub. Date: Nov. 19, 2026

(54) SYSTEM AND METHOD FOR OPTICAL RANGE DOPPLER DETECTION

(71) Applicant: LIDWAVE LTD., Jerusalem (IL)

(72) Inventors: Yehuda HAI VIDAL, Jerusalem (IL); Uri WEISS, Mevo Beitar (IL)

(21) Appl. No.: 19/143,780

(22) PCT Filed: Dec. 27, 2023
(86) PCT No.: PCT/IL2023/051341

§ 371 Date: Jun. 26, 2025

Related U.S. Application Data
(60) Provisional application No. 63/477,287, filed on Dec. 27, 2022.
(60) Provisional application No. 63/481,401, filed on Jan. 25, 2023.

(51) Int. Cl. G01S 17/89; G01S 7/481; G01S 7/4912; G01S 17/34; G01S 17/58

(52) U.S. Cl. CPC G01S 17/89; G01S 7/4811; G01S 7/4917; G01S 17/34; G01S 17/58

(57) ABSTRACT

A system configured for detection of at least one of range and velocity of a target. The system comprising at least one radiation source and optical arrangement configured to direct the radiation source to form at least one signal beam and two or more reference beams or at least one reference beam and two or more signal beams. The optical arrangement transmits the signal beams toward a target and collects reflected beams from the target and combines all beams to generate an interference beam. The optical arrangement comprises a frequency modulator adapted to generate a selected frequency shift to one or the two or more reference (signal) beams. Detection of frequency components of the interference beam provides data on at least one of velocity and range to the target.

### TECHNOLOGICAL FIELD

The present disclosure is in the field of optical detection and measurement systems and methods and relates specifically to systems and methods for optical detection of target distance and/or velocity.

### BACKGROUND

Range detection of objects plays a key role in various applications ranging from navigation, security, mapping, biomedical applications, and more. The ability to provide accurate and sensitive range data is of high demand for development of autonomous vehicles, and other automated systems. Various range detection techniques utilize electromagnetic radiation in different wavelength ranges and respective properties of the radiation.

There are various well known range detection techniques utilizing electromagnetic (EM) waves. For example, Radar and Lidar systems enable detection of range of a target by utilizing the propagation speed of EM radiation to determine distance of target objects by determining time of travel of EM signals. Additional techniques, such as optical coherence tomography (OCT) exploit interference properties of EM radiation and variations in length of optical path.

WO 2021/199,027 describes a system for range detection. The system comprises at least one beam source arrangement configured to provide illumination of certain coherence length, an optical arrangement, and a detection arrangement comprising at least one detector unit. The optical arrangement comprises optical elements forming at least first and second interferometer arrangements formed of a reference path and an interrogating path. The interrogating paths direct beam portions toward a target object and collect beam portions reflected therefrom. The reference path and interrogating path are combined to generate an interference signal on at least one detector of the detection arrangement generating detection data comprising at least first and second detected signals. Wherein, the first and second interferometer arrangements are configured with respective first and second different coherence factors, associated with at least one of (a) optical path of reference paths of the first and second interferometer arrangements, and (b) coherence length of beam passing in said first and second interferometer arrangements. A relation between said at least first and second detected signals is indicative of a distance to said target object.

WO 2023/053,111 describes optical system and respective method. The system comprising one or more coherent light, an optical arrangement, and a detection unit. The optical arrangement comprises optical elements forming at least first and second interferometer loops, each comprising a reference arm and an interrogating arm and are associated with at least first and second detectors of the detection unit. Light propagating in said interrogating arm is directed at a target object via an output optical element and a reflection of light from said target object is collected by an input optical element. The detection unit is configured to determine data indicative of a relation between signals detected by the at least first and second detectors. One of said first and second interferometer loops comprises a first noise generator positioned to affect light propagating in both of the corresponding reference and interrogating arms, thereby affecting coherence of light in said interferometer loops.

### GENERAL DESCRIPTION

Interferometric/coherent systems are commonly used for measuring frequencies at different wavelength ranges (e.g., optical or radio frequency). The measured frequency may represent some physical entity in the real world, depending on the application (e.g., range, vibration, velocity, etc.).

There are number of methods to utilize optical interference for range and/or velocity measurements. Some known techniques such as FMCW and FCR (also known as CTC) are based on interferometric measurement, where a light source is split into two portions; first portion is called the signal or interrogating beam, and the second portion is called the reference beam or local oscillator (LO). Such methods are generally described in WO 2021/199,027 and WO 2023/053,111, assigned to the assignee of the present application, and incorporated herein by reference. The interrogating beam is used to illuminate a target, and part of the back reflection of the beam is collected by the system. The back reflection is then mixed/interfered with the local oscillator, and the interference is analyzed, usually in the frequency domain using a Fourier Transform, and from the analysis the range and/or velocity is determined/calculated.

Typically, to provide accurate data using these methods and systems, detection of two separate signals is needed, e.g., using two detectors or one detector with time division. These two signals are used to eliminate ambiguities in the collected data, associated with e.g., unknown reflection level of the target, collection of a portion of the reflected light, and/or ambiguity in direction of frequency shift.

The present disclosure provides systems and methods configured for determining at least one of range and/or velocity of one or more target objects. The technique of the present disclosure may allow relatively low-cost hardware and electronics. Further, the system and/or method of the present disclosure may operate while using a single time varying signal and may thus utilize a single detector or provide output data based on detection of single signal measurement. This simplifies the routing and construction of the optical system and simplifies the sampling of the signal and the number of calculations needed to perform the range measurement. All of these are combined to significantly decrease the cost of such range measurement systems.

More specifically, according to some embodiments, the present disclosure provides a system comprising a radiation source unit emitting at least one radiation beam of selected coherence properties, a beam splitting arrangement receiving the emitted radiation beam and directing the emitted radiation beam along at least one signal beam and two or more reference beams (or along two or more signal beams and at least one reference beam), and for combining the at least two reference beams and a reflected beam collected from the one or more target objects. The system generally also comprises a detection unit configured for detecting combined beam formed of the at least two reference beams and the reflected beam, and to provide detection data indicative of at least one of distance between the system and said one or more targets and relative velocity of the one or more targets with respect to the system. The system may also comprise one or more modulation units positioned along at least one propagation path of the at least one signal beam and two or more reference beams and configured to provide different modulation between the at least two reference beams. Further the system may also comprise a transmission/collection arrangement configured for transmitting the signal beam toward one or more targets and collecting reflected beam to be combined with the at least two reference beams.

Selected, and different, modulations of one or more of the signal and reference beams, provided for distinguishing between the beams and enables to remove ambiguity associated in detection of signal frequency. In some embodiments, proper modulation can be used to remove ambiguity in direction of frequency shift, indicating direction of velocity of the one or more target objects. In some further embodiments, selected modulation enables determining combined distance and velocity of the one or more target objects.

Thus, according to a first broad aspect, the present disclosure provides a system comprising at least one radiation source providing coherent radiation beam of a selected frequency range, an optical arrangement, and a detection unit;
said optical arrangement comprises optical elements forming at least first and second interferometer loops, each comprising a reference arm and a signal arm, signal arms of said at least first and second interferometer loops are configured for directing a signal toward one or more target objects and collecting reflected portion of said signal reflected from said one or more target objects;
the detection unit comprises at least one detector configured for detection of interference between radiation propagating in reference and signal arms of said at least first and second interferometer loops;
wherein at least one of said at least first and second interferometer loops comprises a frequency shifter positioned along one of reference or signal arm thereof, thereby generating a selected frequency shift to light propagating therethrough; and
wherein said detection unit is configured to generate output data indicative of frequency components of said interference between light propagating in reference and signal arms of said at least first and second interferometer loops, said data indicative of frequency components being indicative of frequency shift generated by said target object.

According to some embodiments, the at least first and second interferometer loops are partially overlapping.

According to some embodiments, the data indicative of frequency components is indicative of direction and magnitude of frequency shift generated by said target object.

According to some embodiments, the frequency shift generated by said target object is associated with a doppler shift.

According to some embodiments, the system may be configured to provide frequency modulated radiation beam, said frequency shift generated by said target object is associated with range to said target object and its velocity.

According to some embodiments, the system may further comprise a controller configured and operable to receive and process detection data from said detection unit, and to utilize data on frequency components of the detection data to determine at least data on closing velocity and/or range of said target object.

According to some embodiments, the optical arrangement comprises a combined transmission/collection arrangement for directing signal portions toward said target object and collecting reflected signal portions via a common optical element.

According to some embodiments, the optical arrangement comprises a transmission/collection optics configured for directing said one or more signal beams toward a target object and for collecting light reflected from said target object, said transmission/collection arrangement comprises at least one quarter wave plate located in path of signal beam and of reflected light and configured to rotate polarization of reflected light with respect to transmitted beam.

According to some embodiments, the direction of frequency shift generated by said target object is determined in accordance with frequency order between first and second frequency components of the combined beam associated with said selected frequency shift and frequency shift applied by said target object in accordance with relative amplitude between them.

According to some embodiments, at least one of said at least first and second interferometer loops comprises at least one attenuator configured to attenuate amplitude of light portions by a selected factor, thereby signifying a relation between signal components of said at least first and second interferometer loops.

According to some embodiments, the at least one attenuator comprises at least one of attenuation filter, asymmetric beam splitter, or polarizer.

According to some embodiments, the at least first and second interferometer loops comprise at least one transmission/collection arrangement, said at least one transmission/collection arrangement comprises one or more optical elements configured to transmit signal beam toward a selected field of view and provide imaging of the selected field of view for collection of reflected portion of said signal reflected from said one or more target objects.

According to some embodiments, the system may further comprise a frequency filter adapted to filter frequency components associated with said selected frequency shift.

According to some embodiments, the system may further comprise at least one optical amplifier positioned and configured to amplify intensity of beam portions transmitted toward said one or more target objects. According to some embodiments the system may further comprise one or more optical amplifiers positioned and configured to amplify intensity of one or more of the reference beams.

According to some embodiments, the system may further comprise a scanner configured to direct said signal toward one or more target objects covering a selected field of view.

According to some embodiments, the system may further comprise a transmission/collection beam splitting arrangement and a lens arrangement, said transmission/collection beam splitting arrangement is configured to split said signal to a selected number of interrogating beams portions, and said lens arrangement is positioned to direct said selected number of beams to cover a selected number of angular regions within a field of view, thereby enabling detection of frequency shift from a plurality of locations within said field of view.

According to some embodiments, the system may further comprise one or more optical amplifiers positioned in path radiation propagating in said at least first and second interferometer loops, being along at least one of signal arm or reference arm of the at least first and second interferometer loops.

According to a second broad aspect, the present disclosure provides an optical detection system comprising an array of optical systems as described herein above configured to emit a plurality interrogating beams, a lens arrangement and at least one scanner.

According to some embodiments, the lens arrangement is placed and configured to direct each of said plurality of interrogating beams toward a respective angular region along a first axis of a field of view, and wherein said scanner is configured to scan said plurality of interrogating beams along a second, generally perpendicular axis of the field of view.

According to a third broad aspect, the present disclosure provides a system comprising:
a radiation source unit comprising one or more light sources configured to emit radiation of selected coherence properties;
a beam splitting arrangement configured for directing the emitted radiation along at least one signal beam and two or more reference beams, and for combining the at least two beams and a reflected beam;
transmission/collection arrangement configured for transmitting the signal beam toward one or more targets and collecting reflected beam to be combined with the at least two reference beams;
a detection unit configured for detecting combined beam formed of the at least two reference beams and the reflected beam, and to provide detection data;
a frequency shifting unit positioned along propagation path of at least one of said two or more reference beams and configured to apply selected frequency shift to light portions in said reference beam;
wherein the detection unit is configured to provide output data indicative of frequency components of said combined beam, said frequency components being indicative of direction and magnitude of a frequency shift applied by said one or more targets.

According to some embodiments, the radiation source unit comprises at least one laser source.

According to some embodiments, the transmission/collection arrangement comprises one or more optical elements configured for illuminating a selected field of view and for imaging the reflected beam from said selected field of view onto said detection unit.

According to some embodiments, the detection unit comprises a detector array, thereby enabling to provide data indicative of frequency shift applied to the signal beam by different target objects within said selected field of view.

According to some embodiments, the frequency shift applied by said one or more target objects is a Doppler shift indicative of closing velocity of said one or more target objects.

According to some embodiments, the radiation source unit is adapted to provide frequency modulated emitted beam, said frequency shift generated by said one or more target objects is associated with range to said one or more target objects and its velocity.

According to some embodiments, the system may further comprise a controller configured and operable to receive and process detection data from said detection unit, and to utilize data on frequency components of the detection data to determine at least data on closing velocity and/or range of said target object.

According to some embodiments, the system may further comprise at least one attenuator located in path of one of said two or more reference beams to provide predetermined attenuation ratio between said two or more reference beams.

According to some embodiments, the system may further comprise a transmission/collection beam splitting arrangement and a lens arrangement, said transmission/collection beam splitting arrangement is configured to split said signal beam to a selected number of interrogating beams portions, and said lens arrangement is positioned to direct said selected number of beams to cover a selected number of angular regions within a field of view, thereby enabling detection of frequency shift from a plurality of locations within said field of view.

According to some embodiments, the system may further comprise an optical amplifier positioned in path of signal directed toward the one or more target objects. According to some embodiments, the system may further comprise one or more optical amplifiers positioned in path of said two or more reference beams.

According to some embodiments, the transmission/collection arrangement comprises at least one quarter wave plate located in path of signal beam and of reflected light and configured to rotate polarization of reflected light with respect to transmitted beam.

According to a further broad aspect, the present disclosure provides a method for determining direction and magnitude of frequency shift in a signal beam, the method comprising:
providing coherent illumination having a selected wavelength range, splitting said coherent illumination to at least three illumination portions comprising at least one signal portion and at least one reference portion propagating along at least one reference arm;
applying a selected frequency shift to at least one of said at least three illumination portions;
directing the at least one signal portion toward a target object, and collecting signal portions reflected back from said target object;
combining said at least three illumination portions to generate a combined beam, detecting intensity of the combined beam and determining frequency components of said combined beam with a selected sampling bandwidth;
processing said frequency components to determine direction and magnitude of frequency shift applied by said target object on said at least one signal portion.

According to some embodiments, determining a direction of frequency shift comprises determining frequency order between first and second frequency components of the combined beam associated with said selected frequency shift and frequency shift applied by said target object in accordance with relative amplitude between them.

According to a fifth broad aspect, the present disclosure provides an optical system comprising at least one light source providing coherent illumination of a selected wavelength range, an optical arrangement, and a detector unit;
said optical arrangement comprises a beam splitting arrangement adapted to receive illumination beam from said at least one light source, and to split said illumination beam to at least three beams comprising (i) at least two reference beams and at least one signal beam or (ii) at least two signal beams and at least one reference beam; the optical arrangement is configured to direct the signal beams toward a target object, collect light reflected from said target object forming one or more reflected beams, and to interfere said at least three beams to form interfered signal on said detector unit;
wherein said optical arrangement further comprises a frequency shifter positioned to shift frequency of one of said (i) at least two reference beams or (ii) at least two signal beams by a selected frequency shift; and
wherein said detection unit is configured to generate output data indicative of frequency components of said interfered signal, said data indicative of frequency components being indicative of frequency shift generated by said target object.

According to some embodiments, the beam splitting arrangement is adapted to split said illumination beam to un-even portions such that signal intensity in said at least two reference beams or at least two signal beams is different by a predetermined difference.

According to some embodiments, the data indicative of frequency components comprises a predetermined frequency pattern having pattern properties indicative of frequency first associated with said one or more target objects and direction of said frequency shift.

According to some embodiments, the data indicative of frequency components is formed of a peak pattern comprising at least two peaks separated between them by said selected frequency shift, and wherein order of said at least two peaks being indicative of direction of frequency shift caused by signal beam interaction with said target object.

According to some embodiments, the system may further comprise a transmission/collection beam splitting arrangement and a lens arrangement, said transmission/collection beam splitting arrangement is configured to split said signal beams to a selected number of interrogating beams portions, and said lens arrangement is positioned to direct said selected number of beams to cover a selected number of angular regions within a field of view, thereby enabling detection of frequency shift from a plurality of location within said field of view.

According to a sixth broad aspect, the present disclosure provides a system comprising:
a radiation source unit comprising one or more light sources configured to emit radiation of selected coherence properties;
a beam splitting arrangement configured for directing the emitted radiation along at least one signal beam and two or more reference beams, and for combining the at least two beam and a reflected beam;
transmission/collection arrangement configured for transmitting the signal beam toward one or more targets and collecting reflected beam to be combined with the at least two reference beams;
a detection unit configured for detecting combined beam formed of the at least two reference beams and the reflected beam, and to provide detection data;
one or more modulation units positioned along propagation path of the at least one signal beam and two or more reference beams and configured to provide different modulation between the at least two reference beams;
the detection data is indicative of a distance between the system and said one or more targets.

According to some embodiments, the detection unit is configured for detection of combined beam and is configured for operating for detection of said combined beam is a selected sampling rate and selected acquisition time, thereby providing detection data comprising a sequence of detection instances collected along a selected collection period.

According to some embodiments, the system may further comprise a control unit connectable to at least the detection unit for receiving detection data, the control unit is configured for processing the detection data to determine data on distance between the system and said one or more targets.

According to some embodiments, the processing comprises processing of frequency components of the detection data.

According to some embodiments, the system may further comprise filtering of frequency components associated with difference between modulation frequencies of the at least two reference beams.

According to some embodiments, the system may further comprise determining data on closing speed of said one or more target objects in accordance with doppler shift of frequency components.

According to some embodiments, the radiation source unit is configured for emitting a single radiation beam of a selected wavelength range.

According to some embodiments, the radiation source unit comprises two or more radiation sources, each configured to emit radiation of at least first and second different wavelength ranges, said at least one signal beam comprises combined beam of said first and second wavelength ranges.

According to some embodiments, the one or more modulation units comprise one or more phase modulators configured to apply phase noise on radiation passing therethrough.

According to some embodiments, the one or more modulation units comprise one or more frequency shifting modulators configured to apply frequency shifting to radiation passing therethrough.

According to some embodiments, the radiation source unit is configured to emit at least one chirped radiation beam.

According to some embodiments, the one or more modulation units comprise one or more delay lines applying optical path delay to radiation passing therethrough.

According to some embodiments, the one or more modulation units comprises modulation units associated with one or more modulation types selected from: optical path length, frequency chirp, frequency shifting, amplitude/intensity variation and phase noise.

According to a seventh broad aspect, the present disclosure provides a method for determining a distance to one or more target objects, the method comprising using radiation of a selected coherence length, directing at least a first portion of the radiation toward the one or more targets and collecting reflected radiation from the target, using two or more reference beams having different modulation thereon and combining said two or more reference beams and said reflected radiation to a combined beam, detecting said combined beam for a selected period in as selected sampling rate and generating detection data; processing the detection data at least partially in frequency domain and determining distance to said one or more target objects in accordance with the peaks in said detection data.

According to some embodiments, the peaks in said detection data are selected from peak's amplitude and frequency peaks.

According to an eighth broad aspect, the present disclosure provides a system comprising:
a radiation source unit comprising one or more light sources configured to emit radiation of selected coherence properties;
a beam splitting arrangement configured for directing the emitted radiation along at least two or more signal beams and at least one reference beam, and for combining the at least one reference beam and a reflected beam;
transmission/collection arrangement configured for transmitting the two or more signal beam toward one or more targets and collecting reflected beam to be combined with the at least one reference beam;
a detection unit configured for detecting combined beam formed of the at least one reference beam and the reflected beam, and to provide detection data;
at least one of the one or more light sources is configured to emit chirped coherent radiation, providing variation in frequency between reference beams and reflected beam in the detection data, and wherein the detection data is indicative of a distance between the system and said one or more targets.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 exemplifies a system configuration providing interference between signal and reference beams;

FIGS. 2A to 2D exemplify a system for determining one or more parameters of a target object (FIG. 2A), and beating frequencies of collected interference data based on frequency shift of the signal beam (FIGS. 2B to 2D);

FIG. 3A to 3E exemplify a system for determining one or more parameters of a target object using frequency shift of the reference beams (FIG. 3A), and beating frequencies of collected interference data based on frequency shift of the signal beam (FIGS. 3B to 3E);

FIGS. 4A and 4B illustrate schematically two exemplary systems for determining parameters of a target object according to some embodiments of the present disclosure, FIG. 4A illustrates a system utilizing separate transmission and collection optics and FIG. 4B illustrates a system utilizing combined transmission/collection optics;

FIGS. 5A to 5D exemplify detected optical (FIGS. 5A and 5C) and electrical (FIGS. 5B and 5D) frequency data detected in accordance with positive and negative frequency shift to the signal beam according to some embodiments of the present disclosure;

FIG. 6 exemplifies a method for determining value and direction of frequency shift according to some embodiments of the present disclosure;

FIG. 7 exemplifies a system according to some embodiments of the present disclosure utilizing two interrogating beam portions;

FIGS. 8A to 8C illustrates system configuration utilizing frequency modulation and/or variation in coherence length for determining one or more parameters of an object according to some embodiments of the present disclosure, FIGS. 8A and 8B exemplify systems configuration using one or two interrogating beams respectively, and FIG. 8C exemplifies detection data in frequency domain;

FIGS. 9A to 9C, exemplify a system (FIG. 9A) using time delay and/or phase modulation according to some embodiments of the present disclosure, time-frequency plot of the beams (FIG. 9B) and detected data in frequency domain (FIG. 9C);

FIGS. 10A to 10C exemplify a system utilizing frequency modulation and CW beams according to some embodiments of the present disclosure (FIG. 10A), time-frequency plot of the beams (FIG. 10B) and detected data in frequency domain (FIG. 10C);

FIG. 11 exemplifies an optical system according to some embodiments of the present disclosure including a scanner unit for scanning a selected field of view;

FIG. 12 exemplifies an optical system according to some embodiments of the present disclosure configured to illuminate a field of view and collect reflected beams from the field of view to thereby determine data on a plurality of locations within the field if view;

FIG. 13 exemplifies an optical system according to some embodiments of the present disclosure configured to generate a plurality of interrogating beams for detecting parameters within a plurality of locations; and

FIG. 14 exemplifies a region scan configuration for scanning a field of view according to some embodiments of the present disclosure.

### DETAILED DESCRIPTION OF EMBODIMENTS

The present disclosure provides several system configurations/embodiments utilizing optical detection of range and/or velocity of one or more target objects. The present disclosure utilizes two or more reference beams (local oscillators), or two or more signal beams, having selected, different, modulations between them to determine a frequency shift generated by interaction of one or more signal beams with the one or more target objects.

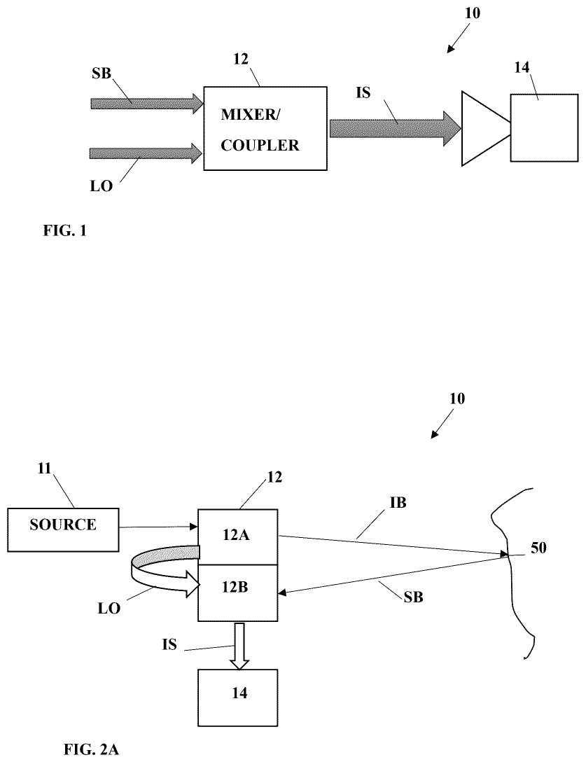

Reference is made to FIG. 1 schematically illustrating an optical interferometric/mixing system 10 for determining an optical frequency shift, usually correlated with the range or velocity of a target object. In this example, an input signal beam SB is collected and combined in a coupler 12 with a reference beam (Local Oscillator) LO, generating an interference signal Iₛ. The interference signal is collected and detected by a detector 14. Typically, the local oscillator LO beam has a selected frequency ω₀, and the signal beam SB has a frequency ωₛ. The signal frequency ωs generally represents certain measured quantity as described in more detail further below. Generally, the detector 14 may be characterized as having sampling bandwidth that includes the interference frequency |ω₀−ωₛ|.

The signal beam SB and the reference LO beam are combined to form interference Iₛ between them in the system, and their interfered signal is sampled by a photodetector 14, operable with a selected sampling bandwidth. The optical frequencies ωₛ and ω₀ may generally be too high to be sampled directly by the photodetector 14, which generally samples average intensity with a selected sampling rate. Thus, typical optical frequencies are beyond the detector's bandwidth. However, the mixing of the two optical signals produces a beating signal at the frequency of the difference between them |ω₀−ωₛ|, and this beating signal may be within the bandwidth of the detector 14. The electrical signal that is produced by the detector can be given by:

I(t)=I_{LO}+Iₛ+2\sqrt{I_{LO}Iₛ}·cos([ω₀−ωₛ]t+φ(t)) (equation 1)

Where I_{LO} and Iₛ are the intensities of the local oscillator beam LO and the signal beam BS respectively, and as indicated above ω₀ and ωₛ are the frequencies of the reference LO and the signal SB beams respectively, t is time, and φ(t) is the relative phase difference at specific time t, between the reference beam LO and the signal beam SB. As known, the cosine function in equation 1 is symmetric so that cos(+x)=cos(−x). This results in detection of absolute value of the difference between the signal frequency and the LO frequency |ω₀−ωₛ|, no matter which one of the frequencies ωₛ or ω₀ is larger.

Generally, equation 1 illustrates various cases, in which a signal beam undergoes a frequency shift in which the desired information lies. However, the detection scheme provides data on absolute value of the frequency shift, which does not include data on direction of the shift.

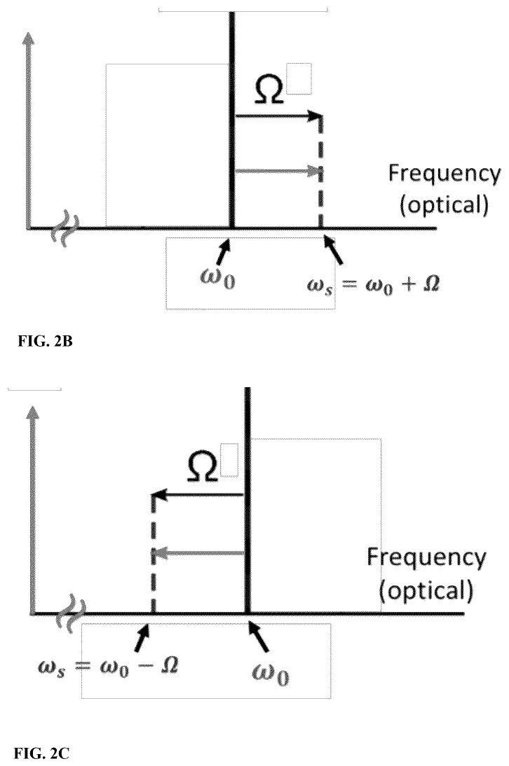

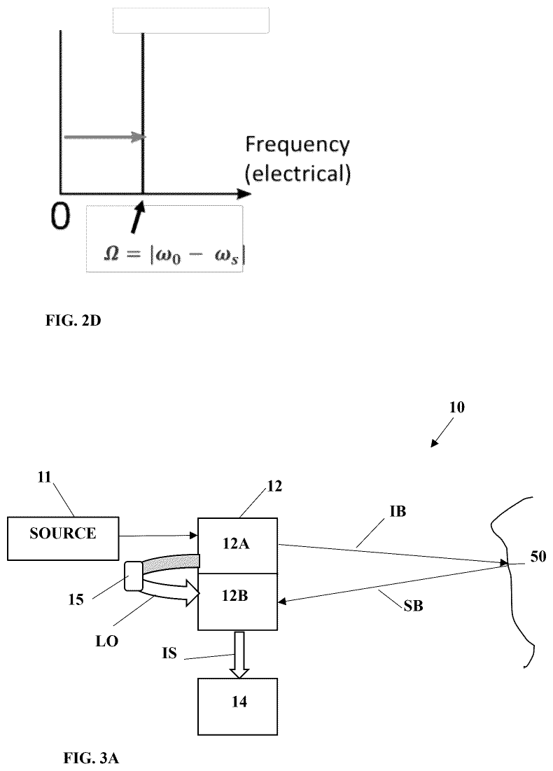

Further, FIGS. 2A to 2D exemplify an interferometric system (FIG. 2A) and data collected by the system and indicative of detected frequency shift, enabling detection of one or more of distance and velocity of an object 50 obtained by the system.

FIG. 2A exemplifies an optical system utilizing the basic operation concept of the example of FIG. 1. As shown, the system 10 utilizes a radiation (light) source 11 emitting coherent beam and a radiation splitting/combining arrangement 12 receiving the coherent beam and generating an interrogating beam IB and reference beam LO (also referred to at times as local oscillator). Radiation splitting/combining arrangement 12 may include a first splitter 12A and a second combiner 12B. The interrogating beam is directed toward one or more target objects 50 and a reflected beam portion SB (signal beam) returning from the target object 50 is collected by the system. The collected reflected beam SB is combined with the reference beam LO by beam combiner 12B generating an interference signal IS, which is collected by a detector unit 14 at a selected sampling rate providing selected detection bandwidth.

In this example, radiation source 11 may be a laser source emitting a light beam at a frequency ω₀. The beam is split into two arms: the reference arm LO remains at the source frequency ω₀, and the signal arm IB is transmitted towards one or more target objects 50, hits the target 50, and a portion of the scattered/reflected light SB is collected by the optical system 10 to extract information regarding the measured target 50 (e.g., its distance, reflectivity, velocity). The collected signal beam SB and the reference beam LO are then mixed (interfered) in the beam combiner 12B, and their interfered signal IS is sampled by a photo detector 14.

Generally, the signal beam may undergo some frequency shift Q while travelling to the target 50 and back into the system 10. This frequency shift may be due to the time it takes for the beam to get to the target and back (e.g., when using range measurement at frequency modulated (FM) systems), a doppler shift due to a moving target, or any other phenomenon that causes a frequency shift that can be measured. As above mentioned, the optical frequencies ω₀=ω₀+Ω, and ω₀ are typically beyond the bandwidth of the photodetector 14, which can typically only determine average intensity within a typical sampling time. However, the beating signal |ω₀−ωₛ| that is produced by mixing the two light beams LO and SB may be within sampling bandwidth of the photodetector 14, causing the photodetector to generate an output electrical signal at frequency |ω₀−ωₛ|, that is the beating frequency.

FIGS. 2B and 2C exemplify the optical frequencies of interference signal IS collected by the detector 14 for the cases of positive frequency shift Ω and negative frequency shift Ω respectively. FIG. 2D illustrates resulting electrical signal of the beating frequency Ω, which is similar regardless of sign/direction of the frequency shift. The electrical signal that is produced by the photodetector can be processed using a Fourier Transform (FT) to present this electrical beating signal at the frequency domain instead of at the time domain and providing output data on the one or more target objects 50.

Accordingly, a main limitation of the interferometric measurement system 10 illustrated in FIG. 2A relates to the system ability to detect the value of the frequency difference Ω, while being insensitive to direction (positive or negative) of this frequency shift. As mentioned above, this is because the frequency of the measured electrical signal is the absolute value of the difference between the LO and the signal beams: |ω₀−ωₛ|=|Ω|, no matter which one of the frequencies ωₛ and ω₀ is larger. Thus, in both cases of a positive frequency shift ωₛ=ω₀+Ω2, as exemplified in FIG. 2B, or a negative frequency shift ωₛ=ω₀−Ω, as exemplified FIG. 2C, the detected spectrum of the output electrical signal is similar as illustrated in FIG. 2D. This limitation results in an ambiguity in direction of the frequency shift, e.g., direction of movement of the target object 50 or its location or both.

This lack of information in the direction of the frequency shift may be significant in many applications. For example, assuming the measured frequency shift is associated with doppler shift of a moving target, it is generally important to know if the target is moving towards the detection system (positive frequency shift) or away from the detection system (negative frequency shift) at a given velocity. However, the basic interferometric measurement systems cannot distinguish between these two scenarios as demonstrated in FIGS. 2A-2D.

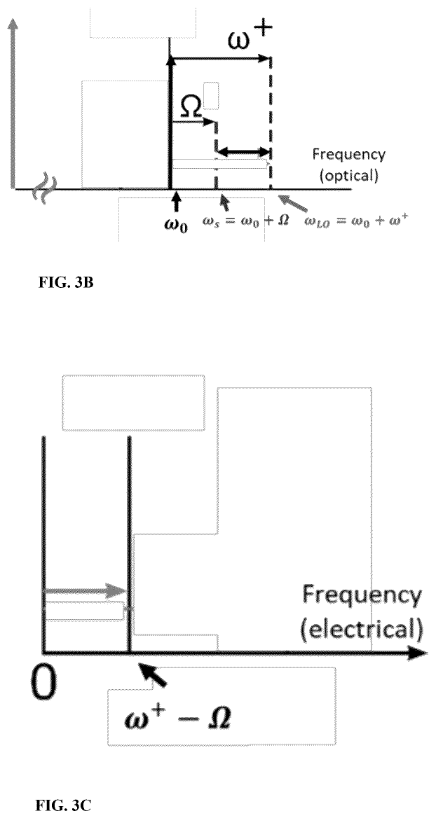

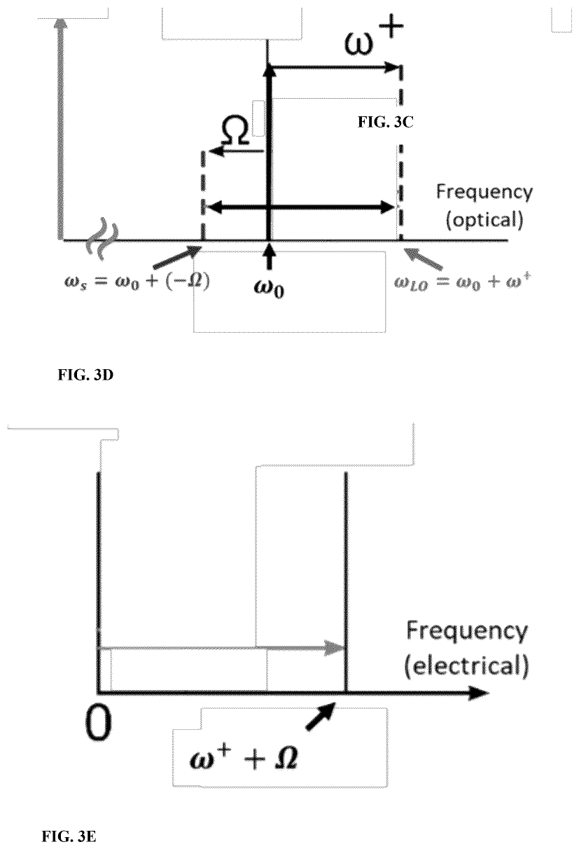

A common solution for the problem of the ambiguity of positive and negative frequency shifts is to add a known frequency shift to the reference arm relative to the signal arm. This is schematically illustrated in FIGS. 3A-3E. FIG. 3A illustrates an optical inspection system similar to that of FIG. 2A, other than an addition of frequency modulator 15 positioned and configured to apply frequency modulation/shift ω⁺ to reference beam LO. FIGS. 3B and 3D illustrates the frequencies of the reference and signal beams in optical frequency domain for positive and negative shift Ω respectively. More specifically, in this configuration the laser source emits light at a frequency ω₀ and the reference arm LO frequency is shifted up by a factor of ω⁺. The signal beam SB undergoes a frequency shift Ω in the measurement process. Accordingly, the signal beam SB that is collected by the system is at a frequency ωₛ=ω₀+Ω, and the reference beam LO in the system is at a frequency ω_{LO}=ω₀+ω⁺. As shown in FIGS. 3C and 3E, the collected signal beam interferes in the system with the LO beam yielding an interference pattern at a beating frequency of:

|ω_{LO}−ωₛ|=|(ω₀+ω⁺)−(ω₀+Ω)|=|ω⁺−Ω| (equation 2)

Enabling to distinguish between positive and negative frequency shift Ω.

This detection scheme is efficient as long as ω⁺≥|Ω|, i.e., the frequency shift that is added to the LO beam is higher than the value of the frequency shift of the signal that can be detected. In these conditions, the system distinguishes between a positive frequency shift of (+Ω) and a negative frequency shift of (−Ω) in accordance with the detected beating frequency as schematically illustrated in FIGS. 3B-3E.

This technique has several disadvantages. For example, if the value of the measured frequency |Ω| is higher than the frequency shift ω⁺ added to the reference arm LO, i.e., ∥Ω|>ω⁺, there is an ambiguity not only in the direction of the shift in measured frequency but also in its value.

Additionally, the detection bandwidth is required to be higher than ω⁺+Ω, demanding high speed (and expensive) detectors. Also, reflections from any optical element in the system may generate strong noise at frequency ω⁺ masking the signal to be detected. These problems require isolation techniques to reduce the effect of the reflections on the performance of the system. Additionally, modulators with high enough bandwidth are usually bulky and expensive, and integrating such modulators into a system may be complex and expensive.

To solve the above deficiencies, the present disclosure provides a system and corresponding method enabling detection of frequency shift to an interrogating beam, including identifying direction of the frequency shift. The underlying principle of the solution of the present disclosure relates to the use of two or more mixed beating signals instead of one. The two or more mixed beating signals may include beating signal associated with frequency shift Ω to be detected, and at least a second beating signal slightly shifted to either Ω+ω⁺ or Ω−ω⁺. The two or more beating signals may have pre-defined relations of the frequency and the magnitude between them such that relative position of the beating signals indicates direction of the frequency shift Ω to be detected. More specifically, the frequency difference between the beating signals is ω⁺, and the direction of the frequency shift Ω can be determined based on position of beating signals. For example, one beating signal may be adjusted with amplitude higher than the other signal, such that a location of the high amplitude signal with respect to the low amplitude signal indicated direction of the frequency shift ω.

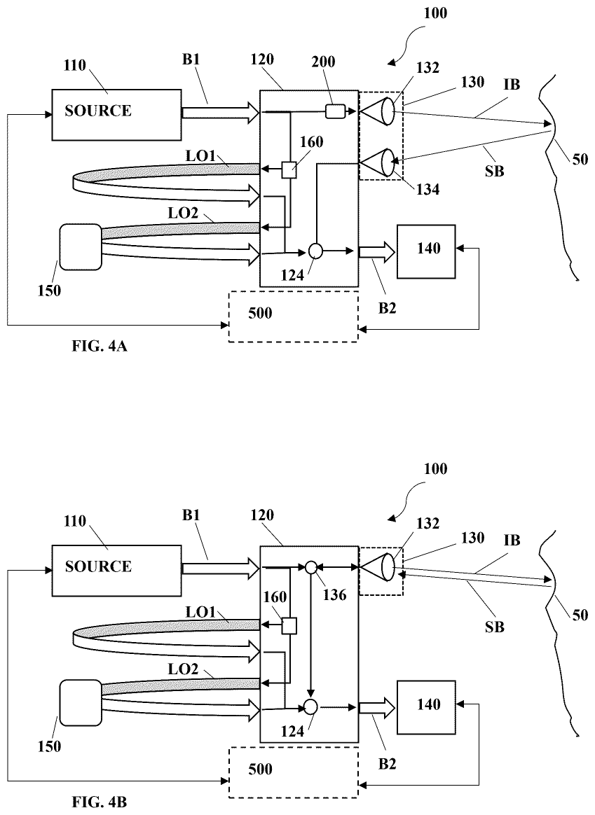

In this connection, reference is made to FIGS. 4A and 4B schematically illustrating two exemplary configurations of optical range and/or velocity (doppler) detection systems 100 according to some embodiments of the present disclosure. In the system of FIG. 4A, transmission/collection arrangement 130 utilizes separate transmission 132 and collection 134 optics and the system of FIG. 4B utilizes combined transmission/collection arrangement 130 including common transmission/collection optics 132 (e.g., including one or more lenses, optionally including one or more shutters and/or apertures). As illustrated, system 100 includes at least one radiation source 110 configured for emitting electromagnetic radiation of selected frequency range and coherence properties. For example, radiation source 110 may include one or more laser light sources operating to provide, pulsed, CW or modulated CW radiation beam B1 having selected wavelength range (frequency range) and coherence length. The system 100 further includes an optical arrangement 120 configured to receive the emitted beam B1 and form at least three beam components including one or more interrogating beam IB propagating along a signal arm, and two or more reference beams propagating along reference arms and forming two or more local oscillators LO1 and LO2. The one or more interrogating beams IB may be transmitted toward one or more target objects 50 using a transmission/collection arrangement 130 configured to transmit the interrogating beam IB toward the object 50 and collect a signal beam SB reflected from the object 50. Transmission/collection arrangement 130 is exemplified in FIG. 4A using transmission optics 132 transmitting the interrogating beam IB, and collection optics 134 collection the reflected signal beam SB. The transmission/collection arrangement 130 is illustrated in FIG. 4B using common optics 132 and beam splitter or circulator 136. Generally, in various embodiments of the present disclosure, circulator, or beam splitter 136 (e.g., polarizing beam splitter) positioned to direct the emitted beam for transmission of the interrogating beam IB and for directing collected beam SB toward collection path described herein below.

In some examples, transmission/collection optics 132 may include a quarter wave plate located upstream or downstream of transmission/collection optics 132. The quarter waveplate may provide polarization rotation of light between output beam and input beam, and thus utilizing the effect of a polarization beam splitter for directing input beam SB to be interfered with reference beams LO1 and LO2. In case of a separate transmission optics 132 and collection optics 134 when used, each of the transmission and collection optics may include a quarter waveplate or a common quarter wave plate can be used.

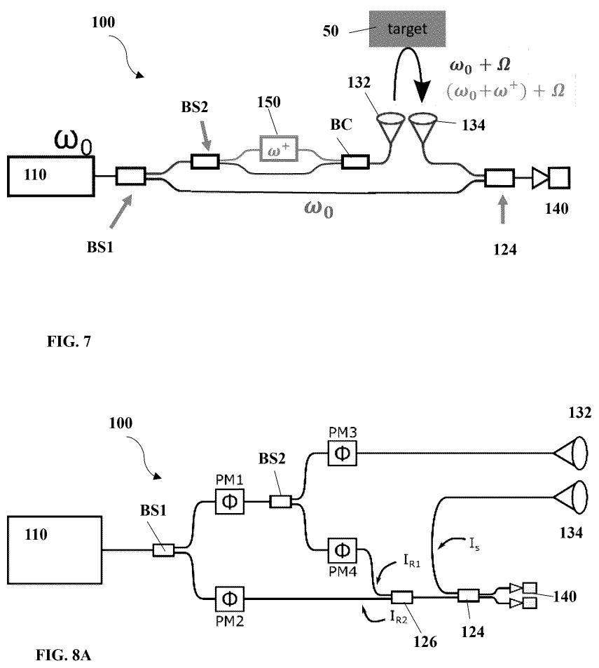

As exemplified in FIG. 4A, the optical system 100 may also utilize one or more optical amplifiers 200 positioned to receive and amplify interrogating beam, prior to transmission/collection arrangement 130. Optical amplifier 200 may be formed by a gain medium, either fiber amplifier or semiconductor optical amplifier, and configured to amplify intensity of the interrogating beam to increase range and signal intensity of the system. The example of optical amplifier 200 is illustrated in FIG. 4A, however, it should be understood that the optical amplifier may be utilized with any configuration of the optical system as described herein including the configurations exemplified in FIG. 4B, and FIGS. 7-14 below. Additionally, in some examples, the optical arrangement may include one or more optical amplifiers located in path of the reference beams LO1 and/or LO2.

The optical arrangement 120 is further configured for directing at least first and second portions of the beam B1 toward at least first and second reference arms LO1 and LO2. The optical arrangement may also include a beam combiner 124 configured to receive the collected signal beam SB and reference beams of the first and second reference arms LO1 and LO2 and to combine the received beams to a combined interference beam B2. The optical arrangement 120, and/or the beam combiner 124 may be further configured to direct the interference beam B2 to be detected by a detection unit 140 including at least one detector (e.g., photodiode, CCD etc.). In some examples, the optical arrangement may include one or more optical amplifiers (not specifically shown) located in path of one or more reference beams LO1 and LO2 and configured to amplify the respective one or more reference beams.

The detection unit 140 includes at least one detector operable in a selected sampling rate to provide a selected detection bandwidth as described in more details further below. Detection unit 140 may be a single detector, or two detectors coupled together to construct a balanced detector. The detection unit provides output data indicative of one or more, and typically two or more beating frequencies of the interference beam B2. The output data on the beating frequencies may provide data on a frequency shift applied to the interrogating beam IB due to interaction with the target object 50, including direction of the frequency shift. The detected frequency shift may be further interpreted to determine one or more parameters of the target object 50, including for example, distance, closing velocity due to doppler shift, etc. Generally, the one or more detectors of detection unit 140 is operable at a selected sampling rate, providing output data in the form of a sequence of intensity levels detected over time. Such sequence output data can be processed, e.g., using Fourier transformation, to indicate one or more frequencies of variation in detected intensity. The frequency bandwidth for detection is determined in accordance with sampling rate of the detector.

According to some embodiments or the present disclosure, system 100 also includes at least one modulator unit 150 positioned in path of at least one of the reference beams LO1 or LO2. Modulator 150 is configured to apply a selected frequency and/or amplitude shift to the respective beam to provide different modulation between the first and second reference beams. In some further embodiments, as described further below, the modulator 150 may be positioned in path of one of two different interrogating beams. To distinguish between the first and second reference beams, optical arrangement 120 may include a beam splitter or attenuator 160 configured to vary amplitude of the first LO1 and second LO2 reference beams to provide different amplitude of the beams, having a selected predetermined level, being a selected difference or a selected ratio. Generally, the modulator 150 may be a frequency modulator, phase modulator, IQ modulator, or other modulator types. The modulator 150 may also be an acousto-optical or electro-optical modulator. In some embodiments, utilizes certain frequency modulation of the output emitted beam, the modulator 150 may also be a delay line as exemplified further below.

System 100 may also include a control unit 500 configured to operating the system and its at least one radiation source 110, and for receiving detection data from the detection unit 140. Control unit may operate to analyze the detection data as described herein below and determine output data indicative of a frequency shift applied by the object 50. The control unit 500 may further operate to determine one or more parameters of the object 50 such as velocity, location, distance, etc. To this end control unit may include one or more processors and memory circuitries, operable to execute selected computer readable code stored on a selected storage unit.

Generally, the system 100 of the present disclosure may be implemented by an optical arrangement 120 forming at least first and second interferometer loops. In the example of FIGS. 4A and 4B, this can be described as a first interferometer loop formed by target beam IB and SB interfering with first reference beam LO1, and separately interfering with second reference beam LO2. Each of the at least first and second interferometer loops includes a reference arm and a signal (interrogating) arm. Combined beam including reference and signal beams of the at least first and second interferometer loops is directed at a detection unit 140 to be detected at a selected sampling bandwidth. According to the present disclosure, at least one of the at least first and second interferometer loops include a frequency shifter 150 along one of its reference or signal arms, causing a selected frequency shift to light passing therethrough.

Alternatively, as described in connection to FIGS. 4A and 4B, the system of the present disclosure is formed of an optical arrangement 120 splitting an input beam B1 into at least three beam portions, including at least one reference beam and at least one signal beam, e.g., two reference beams LO1 and LO2, and one signal beam IB or two signal beams and one reference beam. At least one of the beam paths (e.g., one of two reference beams or one of two signal beams) includes a frequency shifter 150 shifting frequency of the beam portion by a selected shift.

Additionally, according to some embodiments, at least one of the beams (e.g., one of two reference beams LO1 and LO2, or one of two signal beams) has a higher amplitude than the other, and their amplitude ratio is determined to a fix ratio, either by using an un-even beam splitter (e.g., 25:75, 40:60, beam splitter or any other selected splitting ratio) or an optical attenuator 160. The optical arrangement 120 further combines the at least three beams onto a detector unit 140 to generate interference signal B2. The detector unit 140 may include one or more detectors.

Furthermore, the present technique can be realized either by two reference arms and one or more signal arms, or by using two signal arms and one or more reference arms, i.e., transmitting two signal beams differing in their amplitude and frequency and mixing the collected beam with one reference beam. Without loss of generality, the system of the present disclosure is demonstrated herein using a scheme of two reference arms LO1 and LO2. Implementation using two signal arms can be understood with some modifications.

According to some embodiments of the present disclosure, the present technique may utilize a fixed frequency difference between the at least two reference beams LO1 and LO2 (or between at least two interrogating/signal beams as exemplified further below) propagating along the respective reference arms. For example, one of the two reference beams in the system 100 may remain at the original frequency of the radiation source (e.g., laser source at IR, visible or other wavelength range), and the other reference beam undergoes a selected frequency shift ω⁺ by modulator 150. In some other embodiments, a first reference arm may be modulated to apply a frequency shift by a selected frequency shift (e.g., −ω⁺/2) down, and a second reference may be modulated to apply a frequency shifted down by a selected frequency shift (e.g., +ω⁺/2) up. Each of the reference beams LO1 and LO2 are further directed to interfere with the collected signal SB arm to generate combined beam having two or more mixed signal output collected by the detector unit 140. The Interference signal B2 includes two mixed signals, separated in frequency by a shift of ω⁺, which is typically selected to be within detection bandwidth of the detector unit 140. To associate each of the mixed signals to the respective first or second reference arms, the amplitude of the first and second reference arms may be adjusted to reduce one or more reference arms by a selected known factor. This provides a selected known ratio between the amplitudes of the mixed signals, which are separated by a known frequency shift ω⁺. The amplitude ratio may be determined according to selected considerations in the system design. Using that scheme, the value of the measured frequency is obtained by the beating frequency of the interference pattern of the signal beam with one of the reference beams, and direction of the frequency shift to be detected is determined by relative location of a second beating frequency associated with interference between the signal beam SB and the second one of the reference beams, indicating positive or negative frequency shift as explained and demonstrated below.

Turning back to FIG. 4, in some exemplary embodiments of the present disclosure, the system 100 may include a laser light source 110 providing emitted laser beam B1 having a frequency ω₀. The optical arrangement 120 is configured to split light output of the laser unit 110 and direct reference and signal beams to a detection unit 140. The laser beam B1 may be split into two portions: a signal beam IB and a reference beam. The reference beam may be further split into two first LO1 and second LO2 reference beams. In this example, the first reference beam LO1 does not undergo any frequency shift, while the second reference beam LO2 undergoes a small, selected, frequency shift ω⁺. In addition, the amplitude (the optical power) of one of the reference beams may be selected to be different by a known factor. For example, the amplitude of the second reference beam LO2 may be reduced by a known factor with respect to the amplitude of the first reference beam LO1. It should be noted that it does not matter which one of the reference beams is modulated or varied in amplitude with respect to the other one. In this example illustrated in FIG. 4 the amplitude of the second reference beams LO2 is arbitrarily set to be lower than the amplitude of first reference beams LO1. The collected signal beam SB interferes in the system with both reference beams, resulting in a temporal interference pattern including at least two beating frequencies. One of them represents the value of the measured frequency and the second represents the direction (positive or negative) of the measured frequency as explained below.

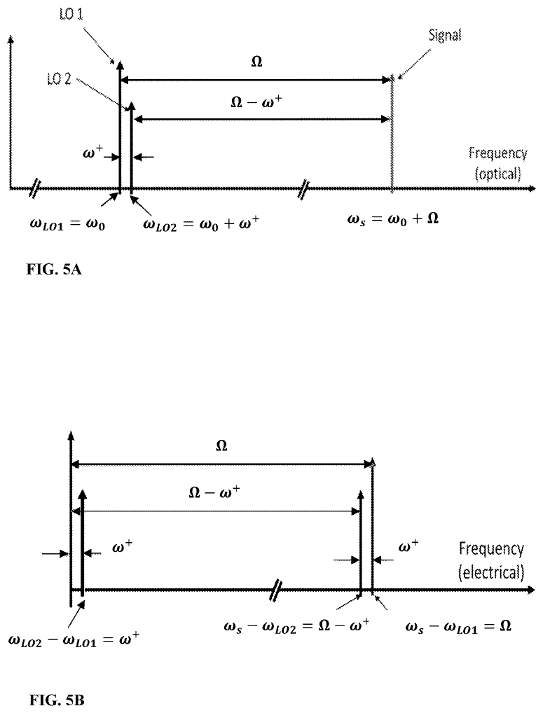

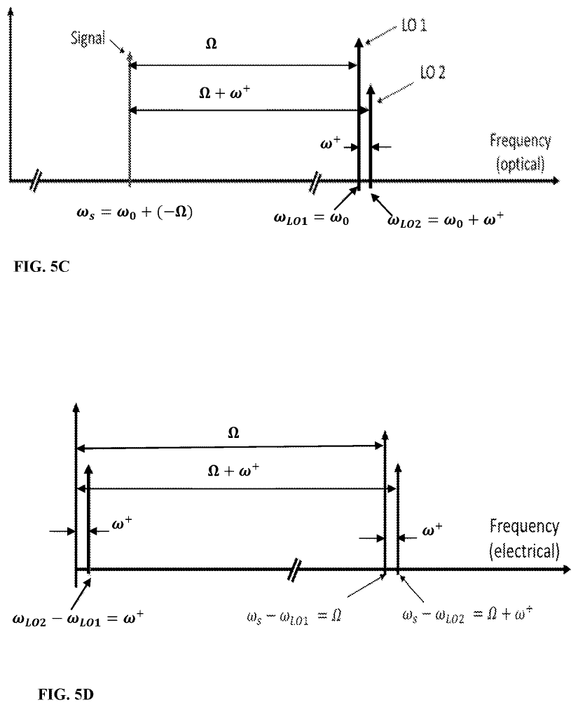

The collected optical signal B2 and respective beating frequencies are described herein mathematically and with reference to FIGS. 5A to 5D. FIG. 5A exemplifies optical signal including frequency of the signal beam SB and beating frequencies of interference of the signal beam with the first and second reference beams for a case of positive frequency shift by the object, and FIG. 5B exemplifies frequencies of electrical signal output of the detector unit 140 for the respective signal. FIG. 5C exemplifies frequencies of the optical signal for the case of negative object frequency shift, and FIG. 5D exemplifies corresponding electrical signal frequencies.

Accordingly, FIGS. 5A to 5D exemplify an analysis of the optical signals that enter the photodetector in the system such as exemplified in FIG. 4 as follows:

The first reference beam has frequency of the radiation source 110: ω_{LO1}=ω₀, and its electromagnetic wave (neglecting the phase φ term) can be described by:

E_{LO1}e^{-iω}^{_{LO1}}^{t}=E_{LO1}e^{iω}^{₀}^{t}

The second reference beam has the radiation source frequency shifted by ω⁺ from ω₀ providing: ω_{LO2}=ω₀+ω⁺, and its amplitude is lower by a selected factor from that of the first reference beam, so that: E_{LO2}<E_{LO1}. Thus, its electromagnetic wave is (neglecting phase term):

E_{LO2}e^{-iω}^{_{LO2}}^{t}=E_{LO2}e^{-i(ω}^{₀}^{+ω}^{⁺}^{)t}

The collected signal beam has frequency ω₀ shifted by an unknown frequency shift Ω providing data on the one or more target objects. Accordingly, the frequency of the collected signal is ωₛ=ω₀+Ω. Its amplitude depends on the system, the target, and the measurement conditions, and is generally unknown. The electromagnetic wave of this signal is (neglecting phase term):

E_{SIG}e^{-iω}^{ₛ}^{t}=E_{SIG}e^{-i(ω}^{₀}^{+Ω)t}

The electromagnetic wave of the mixed optical signal B2 is the superposition of the first LO1 and second LO2 reference beams and the signal beam SB. Thus, the electromagnetic wave that enters to the photodetector 140 is given by (neglecting phase term):

E_{Total}=E_{LO1}e^{-iω}^{₀}^{t}+E_{LO2}e^{-i(ω}^{₀}^{+ω}^{⁺}^{)t}+E_{SIG}e^{-i(ω}^{₀}^{+Ω)t}

The detected signal B2 thus contains three optical frequencies ω₀, ω₀+ω⁺, and ω₀+Ω. The electrical signal that is produced by the detector contains three interference patterns associated with the differences between these frequencies, including ω⁺, Ω, and Ω±ω⁺. A relation between the interference patterns and the respective frequencies provides direct indication to direction and magnitude of the unknown frequency shift Ω as described below and can be directly determined from the electrical frequency of the collected signal. In this analysis, the electromagnetic signals are described while neglecting the phase term φ, which typically does not play a part in the resulting signal.

Considering first the case of a measured positive frequency shift Ω>0, e.g., target object 50 propagating toward the system. FIG. 5A shows the three different frequencies of the beams at the optical frequency domain. The first reference beam LO1 frequency is the same as the laser frequency: ω_{LO1}=ω₀. A small frequency shift, ω⁺, is added to the second reference beam LO2, having lower amplitude, resulting in: ω_{LO2}=ω₀+ω⁺. The signal beam SB is frequency-shifted at a positive frequency shift (+Ω), so that the collected signal has optical frequency ωₛ=ω₀+Ω.

The mixed output signal collected by the detector 140 is indicative of the beating frequencies ω⁺, Ω, and Ω±ω⁺. The electrical signal may generally contain three different frequencies as illustrated in FIG. 5B. Generally, the base radiation frequency ω₀ is beyond sampling bandwidth of the detector 140. The mixed signals generating beating frequency data on the detector 140 are noted as: LO1-LO2; LO1-SIG; and LO2-SIG.
1. LO1-LO2: The interference between the two reference beams at a frequency |ω_{LO2}−ω_{LO1}|=ω⁺. This is a known predetermined frequency shift between the first and second reference beams.
2. LO1-SIG: The interference between the first reference beam LO1, e.g., of higher amplitude, and the signal at a frequency |ωₛ−ω_{LO1}|=|Ω|. Providing magnitude of the detected frequency.
3. LO2-SIG: The interference between the second reference beam LO2, e.g., of lower amplitude, and the signal at a frequency |ωₛ−ω_{LO2}|=|Ω−ω⁺|.

The interference between the two reference beams does not contain any information regarding the measured signal frequency. The frequency ω⁺ of reference beams interference is constant to the system and independent of the target object, as both reference beams are kept in the system. Thus, the interference between the reference beams is not affected by the measured signal. This signal can be easily filtered by adding a high-pass-filter to the system analogously or digitally. Since the frequency of this signal can be determined to be small it can be filtered out efficiently.

The LO1-SIG interference represents the value of the signal frequency, Ω, while does not provide data on its direction.

The LO2-SIG interference holds the information regarding the direction (positive or negative) of the frequency shift Ω. In both positive and negative frequency shifts the LO2-SIG is shifted by ω⁺ in relation to LO1-SIG. The difference between positive and negative frequency signal is the direction in which it is shifted. In case of a positive frequency Ω>0 the LO2-SIG is at a lower frequency than the LO1-SIG, i.e., at |Ω|−ω⁺. Alternatively, as demonstrated below in FIG. 5D, in case of a negative frequency shift, i.e., Ω<0, the LO2-SIG is at a higher frequency than the LO1-SIG, i.e., at |Ω|+ω⁺.

According to some embodiments, as exemplified in FIGS. 4A and 4B, system 100 may include a control unit 500 operable for receiving and analyzing detected signal received from the detection unit 140. Typically, the detected signal may be analyzed in frequency domain, i.e., temporally detected signal may be processed to determine frequency thereof. Accordingly, the detection unit 140 and/or the control unit 500 may include a Fourier transform module configured for converting temporal detection data to frequency domain to determine spectral components of the detected data.

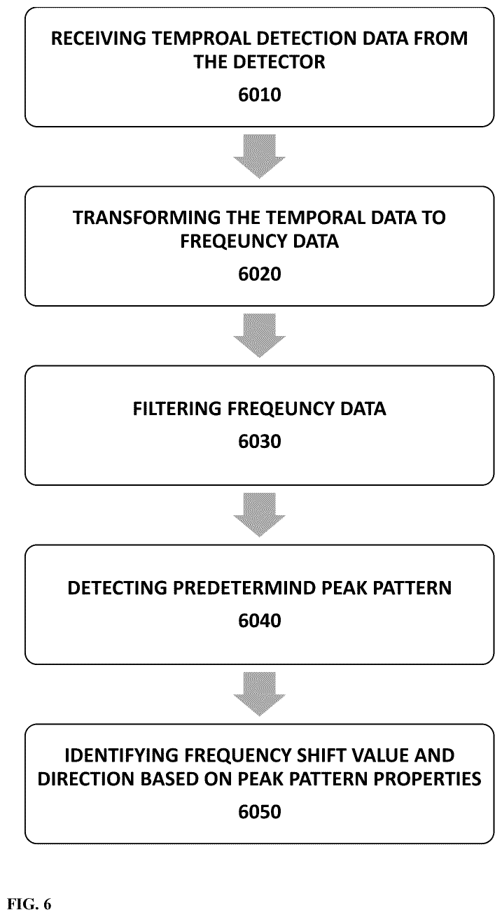

Upon determining frequency content of the detection data, according to some embodiments, the control unit 500 may operate to analyze the data as exemplified in FIG. 6. More specifically, as illustrated in FIG. 6 the method may include receiving temporal detection data from the detector 6010 and transforming the temporal detection data to frequency data 6020. Additionally, the analysis may include filtering the frequency data (analogously or digitally) 6030. The filtering may include a high-pass filter to remove a reference beam interference frequency ω⁺ and general noise and/or equalize any distortions in the frequency domain due to imperfections in the system.

To determine frequency shift, the analysis may include detecting a predetermined peak pattern 6040 within the frequency data. As indicated above, the peak pattern generally includes a first peak at frequency |Ω|, and a second peak at frequency |Ω±ω⁺| having a predetermined intensity relation with the first peak. Utilizing the predetermined peak pattern, data on frequency shift Ω, including frequency value and direction (sign) can be determined 6050.

More specifically, the method may utilize detection of the first, highest peak, and following detection of the highest peak, the method may include detecting a second peak at a frequency distance of ω⁺ from the frequency of the highest peak Ω. The second peak may have amplitude lower by a predetermined factor with respect to the first peak. The amplitude ratio is associated with a pre-set amplitude ratio between the first and second reference beams. The second peak relates to the LO2-SIG interference, and by identifying its relative location, being of higher or lower frequency with respect to the highest peak, the method can determine sign of the frequency shift.

For example, FIGS. 5A and 5B exemplify positive frequency shift Ω resulting with a peak pattern formed by a second peak being to the left of the first peak Ω (i.e., at Ω−ω⁺) in FIG. 5B. Further, FIGS. 5C and 5D exemplify negative frequency shift Ω resulting with a peak pattern formed by a second peak being right to the first peak Ω (i.e., at Ω+ω⁺) shown in FIG. 5D, indicating that the direction of the measured frequency Ω is negative.

Accordingly, as described herein, the system, and respective method of the present disclosure enables optical measurement of one or more parameters of an object, including e.g., distance, velocity, and other parameters that can be manifested by a frequency shift to an interrogating beam, and allows for differentiating between positive frequency shift and negative frequency shift. Additionally, the technique of the present disclosure utilizes signals having a specific peak pattern in frequency domain as exemplified in FIGS. 5B and 5D, making it efficiently recognizable even at a noisy environment. The output electrical spectrum pattern contains peak pattern formed by two peaks that are separated by a specific and known frequency shift, ω⁺, and manifesting a specific and known amplitude/intensity ratio between the peaks. Thus, the system of the present disclosure is robust to noise. This is as recognizing such a specific peak pattern at a noisy environment (due to noises in the system or in the environment or due to a weak signal) is more reliable than recognizing a single peak (as usually done in interferometric systems with one LO) that might be generated by a random peak in the noise or hidden by the noise.

Considering detection of a negative frequency shift Ω<0 affecting the signal beam as illustrated in FIG. 5C. Again, the LO1 and LO2 frequencies are just as before: ω_{LO1}=ω₀, and ω_{LO2}=ω₀+ω⁺. But the signal is now frequency-shifted at a frequency (−Ω), so that the collected signal's optical frequency in the system is ωₛ=ω₀−Ω.

The mixed output (in the electrical spectrum) of the system contains again three frequencies as illustrated in FIG. 5D, LO1-LO2, LO1-SIG, and LO2-SIG.
1. LO1-LO2: The interference between the two LO beams at a known frequency: |ω_{LO2}−ω_{LO1}|=ω⁺.
2. LO1-SIG: The interference between the (higher amplitude) LO1 and the signal at a frequency: |ωₛ−ω_{LO1}|=|Ω|.
3. LO2-SIG: The interference between the (lower amplitude) LO2 and the signal at a frequency: |ωₛ−ω_{LO2}|=|Ω+ω⁺|.

The first two signals (LO1-LO2 and LO1-SIG) are the same as in the case of the positive frequency shift. It is understood since as above mentioned the LO1-LO2 is not affected by the measured signal and the LO1-SIG represents only the value of the signal frequency and not its direction.

However, the LO2-SIG (that represents the direction of the signal frequency shift) at a frequency Ω+ω⁺ differs from the positive frequency shift case (in which the signal was at a frequency Ω−ω⁺). Note that in the case of a positive measured frequency shift the higher of the pair of the peaks is the right one (FIG. 5B), and in the case of a negative measured frequency shift the higher of the pair of the peaks is the left one (FIG. 5D).

Thus, the present disclosure, according to some embodiments, describes a unique interferometric\coherent system and method, configured to determine a frequency shift to a signal beam (e.g., doppler shift applied by a target object) where the system is capable of determining direction and magnitude of the frequency shift. The present technique removes ambiguities in the measured frequency shift direction, while operating of sensing arrangement having a selected bandwidth sufficient to detect the desired frequency shift Ω. This is different than other technique using known frequency shift larger than the desired frequency shift Ω, which require to expand the bandwidth of the system.

Further, as indicated above, the system of the present disclosure may utilize common transmission and collection optics. This system configuration typically simplifies system alignment, but generate additional results associated with reflection of the transmitted beam being collected by the system. As described above, such reflection signal, similarly to interference signal between the reference beams, may be filtered out using high-pass filter (HPF) on sampling analogously or digitally at the designed frequency ω⁺.

Thus, the present disclosure provides a system and method for optical measurement of frequency shift of a signal beam. This may be used for distance measurement using frequency modulated beam B1, optical measurement of doppler shift applied by one or more target objects, or other factors that may generate frequency shift to optical signal. As described, the present technique utilizes interference of a signal beam having unknown shifted frequency ω, to be determined with main frequency beam ω₀ and shifted frequency beam ω₀+ω⁺. This may be implemented using two reference beams and a single signal beam, or two signal beams (where one is shifted by ω⁺) and one reference beam.

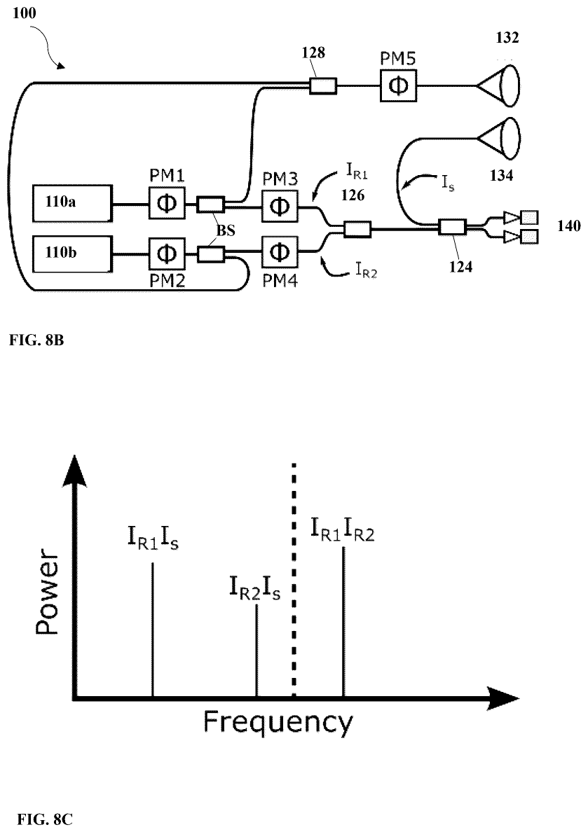

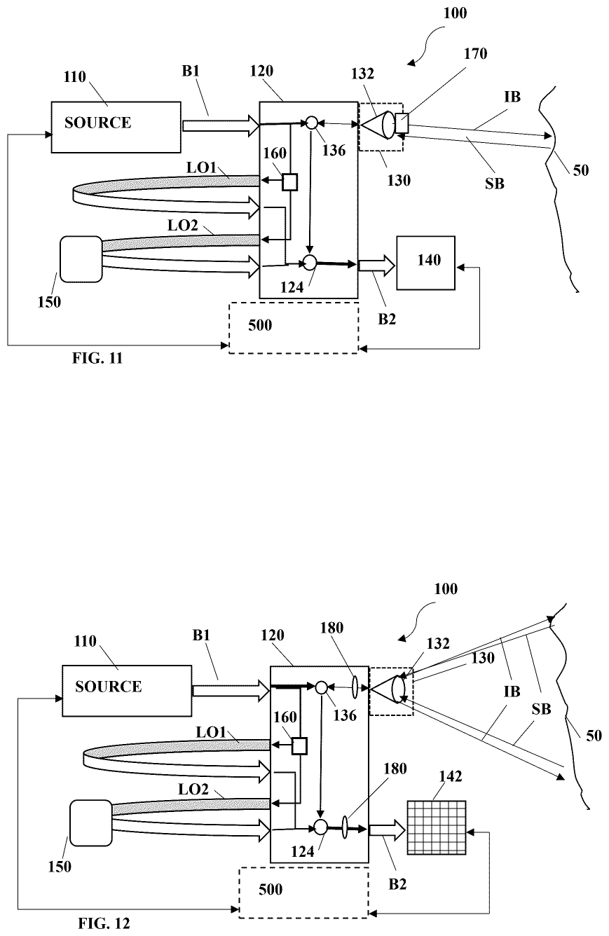

Further to the exemplified configuration of FIGS. 4A and 4B, the system of the present disclosure may utilize several other configurations as exemplified herein below in FIG. 7, FIGS. 8A-8C, FIGS. 9A-9C, FIGS. 10A-10C, as well as FIGS. 11 to 14. In this connection, and as described herein in general, the system of the present disclosure may be implemented using various optical arrangements, including for example, free space propagation of optical radiation, optical fiber arrangement, waveguide arrangement, photonic integrated circuit, planar Lightwave circuit, or any combination of these configurations. Selection of type of optical path in which the system is implemented may be based on application, required stability and robustness of the system and/or costs.

FIG. 7 illustrates a system 100 configuration using two signal beams and one reference beam. More specifically, the radiation source 110 generated output beam at frequency ω₀. The beam is first split to interrogating arm and reference arm using a first beam splitter BS1. The reference arm propagates toward a beam combiner 124. The interrogating arm includes a second beam splitter BS2 splitting the beam into first and second beam portions, where a first beam portion is maintained at original frequency ω₀, and the second beam portion is frequency shifted by modulator 150 by the known shift ω⁺. The two interrogating beam portions are combined using beam combiner BC and transmitted toward a target using transmission optics 132. Reflected radiation from the target is collected by collection optics 134 and combined using beam combiner 124 with reference beam to generate interference signal, which is detected by detector 140.

In this configuration the system utilizes two or more signal beams having a frequency shift ω⁺ between them, while being transmitted using common transmission optics 132. The collected signal is collected using collection optics 134 forming a bistatic optical arrangement. As described above, with reference to FIG. 4B, the optical system 100 may be configured as a monostatic optical system utilizing common transmission and collection optics. Further, as described above, the amplitude of one of the signal beams is reduced by a known factor compared to the other. This configuration may utilize signal detection and analysis, similar to the technique exemplified in FIGS. 5A to 5D and FIG. 6.

FIGS. 8A to 8C exemplify an additional configuration of the present disclosure. FIG. 8A illustrates optical measurement system 100 utilizing first and second reference beams and one interrogating beam. As illustrated in FIG. 8A, a radiation source 110 provides radiation of selected frequency ω₀. The radiation beam is split by a first beam splitter BS1 to first and second beam portions, and using second beam splitter BS2, providing three beam portions. This provides a first reference beam I_{R1}, second reference beam I_{R2} and signal beam Iₛ. The two reference beams I_{R1} and I_{R2} are combined to a single reference beam (local oscillator) using beam combiner 126. The signal beam Iₛ is sent to illuminate a target using a transmitting optical arrangement 132, and back reflections are collected by a receiver optical arrangement 134 (Generally, transmission and collection optics may be common optics as described above). The system further includes phase modulators (PM1-PM4) or other frequency shifting modulator positioned in path of the first and second reference beams and signal beam. Phase modulator PM1 may be positioned downstream of beam splitting element for generating phase variations (e.g., phase noises) to adjust coherence length of light propagating in one reference arm I_{R1} with respect to light propagating in the other reference arm I_{R2}. This allows the system to provide different coherence lengths of light propagating in the first and second interferometers. Phase modulators PM2, PM3 and PM4 are operated at different frequencies to provide different phase modulations and/or different frequency shifts to the respective beams. This configuration provides frequency differences between each pair of the three beams I_{R1}, I_{R2}, Iₛ. The reference beams I_{R1}, I_{R2} are combined using beam combiner 126 providing a dual frequency local oscillator, which is then mixed using beam combiner 124 with reflected signal beam Iₛ collected from the target to provide a resulting interference signal. the resulting interference signal is detected by a single detector 140, being a photodiode, CCD, or any other detection, or, in some embodiments, a balanced detector. The detector 140 generally operates for detection of the interference signals within a selected sampling rate and a selected detection/measuring period, to provide a sequence of intensity measurements that can be converted into Fourier space indicating modulation frequencies of the reference and signal portions. The signal on the detector is analyzed in the frequency domain to determine frequency shift to the signal beam in accordance with power in peaks associated with differences between modulation frequencies of the signal beam and each one of the first and second reference beams.

FIG. 8B illustrates an additional system 100 configuration, using first and second radiation sources 110a and 110b providing radiation beams of first and second different frequencies. The output radiation is split into interrogating beams and reference beams using beam splitters BS. In this configuration, the system provides two interrogating beams, and respective reference beams I_{R1} and I_{R2}. The radiation sources may be first modulated using modulators PM1 and PM2, and are combined and transmitted toward a target object via optics 132. In some configuration the combined interrogating beam may be further modulated by PM5. Reference beam portions may also be modulated using modulators PM3 and PM4, and are combined via beam combiner 126, and then combined with collected signal beam Iₛ using beam combiner 124. The generated interference beam is collected by detector 140.

The two sources 110a and 110b are preferably well separated in their frequencies, preferably to provide beating frequency between the two reference beams (or lasers) to be well above the bandwidth of the photodetector. In this manner, the local oscillators interference, which does not carry any information is filtered out easily by the detector itself.

FIG. 8C shows an exemplary interference signal in the frequency domain. Generally, the frequencies associated with interfering signal portions I_{R1}Iₛ and I_{R2}Iₛ being interference between the collected signal beam and the reference beams, include unknown frequency to be detected. This frequency may be associated with doppler shift (due to the object velocity) caused by the target object. These interference signals are shifted in the same frequency Ω, as the doppler shift occurs due to the signal beam Iₛ and does not affect the reference beams. Thus, this shift is similar to the interference of the signal beam with the different reference beams. Additionally, the interference between the reference beams I_{R1}I_{R2} is not doppler shifted, as the reference beams do not leave the system. Thus, the signal peak associated with difference between modulation frequencies of the reference beams I_{R1}I_{R2} is of predetermined frequency and has relatively high power. This signal peak carries no information about the target and may be filtered out. Generally, it is preferred to filter it out analogously or digitally, which is convenient as it is not being shifted due to the doppler effect. Additionally, the interference frequency of the two local oscillators I_{R1}I_{R2} can be selected to be at specific frequency that is easy to filter out.

The detected interference frequencies exemplified in FIG. 8C may enable additionally to determine distance to the target object using relation between amplitude of the two signals I_{R1}Iₛ and I_{R2}Iₛ. This may be associated with coherence length of the interrogating signals and respective reference beams, as well as difference in coherence length between the signal and/or reference beams as described in more details below. These signals may be collected using a single photodetector and obtained using common signal processing system. Accordingly, the system may utilize a single detection unit operatable with a selected sampling rate for a selected signal detection time for each range detection instance. The system described herein can be used for FCR range detection technique and may also be used in accordance with FMCW range detection technique. Typically, both FCR and FMCW techniques need two signals for accurate range and/or velocity detection. Generally, in FMCW techniques, the frequencies of the two signals are used to determine the range to the target, and in FCR, the relative power/amplitude of the frequencies (and not their exact frequencies) are used for the same manner.

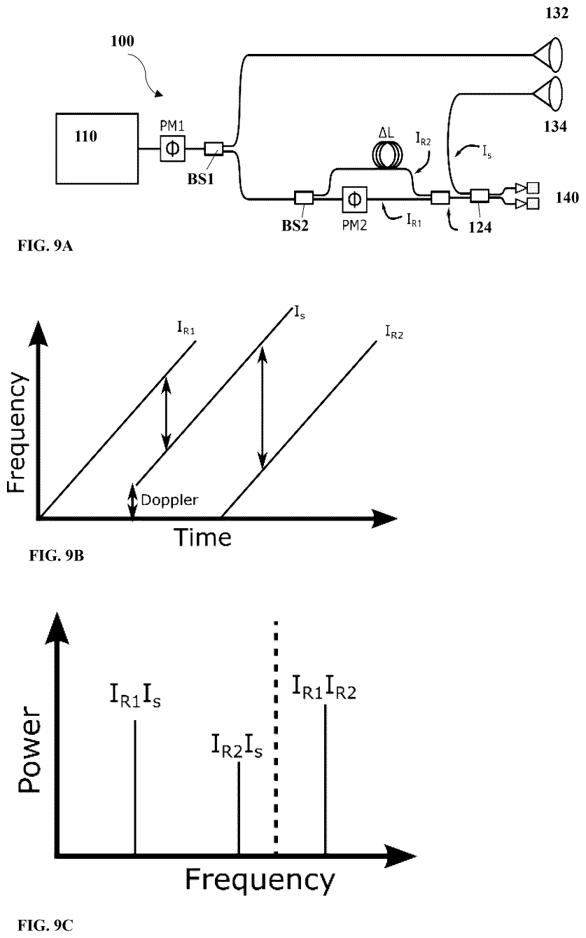

An additional system configuration according to some embodiments of the present disclosure is illustrated in FIGS. 9A to 9C. In this example shown in FIG. 9A the optical system 100 includes light source 110 emitting a radiation beam, which is split into three portions using beam splitters BS1 and BS2. A signal beam generated by the split is transmitted toward a target object via optics 132, and reflection is collected using collection optics 134 (or using common transmission/collection optics as described above). Two reference arms I_{R1}, and I_{R2} are used in the system. One of the reference arms (in the figure I_{R2}) is delayed using a delay line of length ΔL with respect to the other one. Alternatively, or additionally, one of the reference arms (in the figure I_{R1}) is transmitted through phase modulator PM2 applying phase modulation or frequency shift, or both options together. The two reference beams are then mixed to one local oscillator, which is then mixed with the received signal collected after illumination of the target with the signal beam using beam combiners 124. The resulting interference is detected by a photodetector 140. The frequency of the interference of I_{R1}Iₛ is selected to be different than the frequency of the interference between I_{R2}Iₛ using delay line ΔL and/or modulator PM2.

As indicated above, the system may be operable using FMCW technique, e.g., output beam may be modulated using PM1. This is exemplified in FIG. 9B showing frequency-time plot of the signal and reference beams. In this technique, the frequency difference between the reference beams I_{R1}, and I_{R2} is due to the difference in length of the reference arms. Generally, this is since in FMCW difference in length results in frequency shift due time delay of the beam. Additionally, or alternatively, phase modulator PM2 can be used to create a frequency shift between the reference beams, when operating in FCR, the frequency shift is a result of the phase modulator/frequency shifter PM2. Similarly, to the previous system described above, the interference of the two local oscillators may be filtered out, either analogously or digitally, or may be outside of the bandwidth of the detector 140, as illustrated in FIG. 9B.

FIGS. 9B and 9C illustrate the frequency chirp and frequency analysis in the FMCW method. For the FCR method, the frequency domain is generally similar to FIG. 8C. The distance to the target may be determined in accordance with relation between power of the signal peaks as shown in FIG. 9C. The frequency chirp illustrated in FIG. 9B shows the delay between the reference arms and signal beam along time.

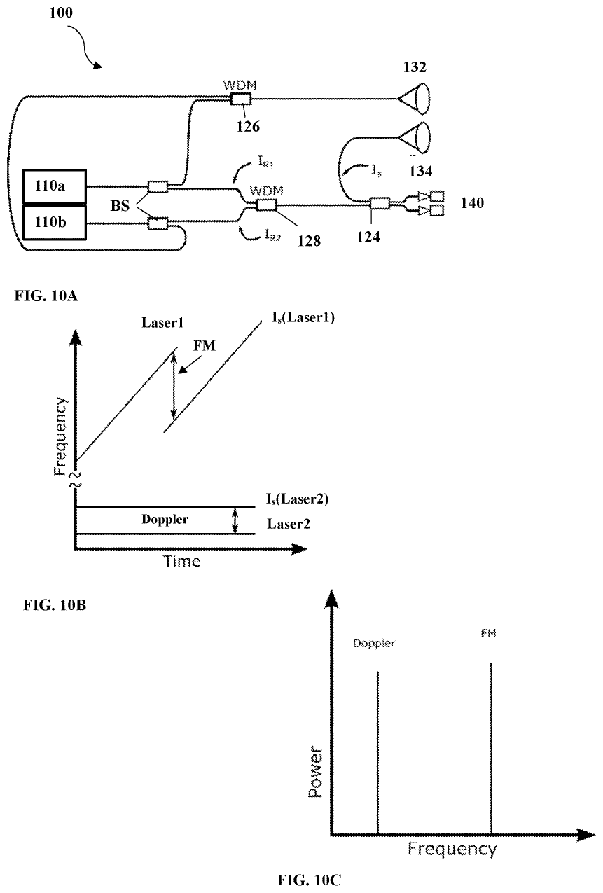

A further system configuration is exemplified in FIGS. 10A to 10C. FIG. 10A exemplify a system 100 configuration operating using the general concept of FMCW range detection, while simplifying the chirp method and operating using a single detector 140. The system includes first and second radiation sources 110a and 110b, each generating radiation beam having selected different first and second frequencies. Output beams from the sources 110a and 110b are split into signal and reference beams using beam splitters BS. The signal beams are combined using wavelength demultiplexer beam combiner 126 and transmitted toward a target object through transmission optics 132. Reflected beam from the target is collected using collection optics 134 providing a signal beam Iₛ. The reference beams are combined using beam combiner 128 and the combined reference beam is combined with signal beam using beam combiner 124 and directed to detector 140.

FIG. 10B exemplifies frequency as a function of time for the radiation generated by first source 110a and second source 110b. As shown, output beam of first source 110a is chirped (either up or down), while source 110b provides CW radiation, this reflects to both the reference and signal beams. The signal beams are further shifted due to distance to the object and/or due to doppler shift caused by the object's velocity.

In this configuration, the output signal is chirped one-way (either up or down), together with adding a zero-chirp reference. More specifically, a first source 110a is configured to provide modulated, chirped up or down, output beam, while second source 110b provides continuous wave (CW) beam. The CW signal is used to determine velocity of target object, as it provides beating frequency corresponding to the doppler shift, associated with frequency variation between the signal beam and the respective reference beam. The chirp signal is used to determine a range to the target object. The advantages of having a one-way chirp with respect to up-down chirp relates to number of measurements carried at a given time period over conventional FMCW techniques.

FIG. 10C exemplifies frequency analysis of the collected signals. As described, the two light sources are split into two portions each, providing signal and reference arms for each of the light sources 110a and 110b. As shown, and similarly to the previous systems, the doppler shift is similar for all the beating frequencies, as well as time delay due to distance to the target object. Accordingly, the frequency shift due to doppler effect generates one peak in the frequency domain. The frequency shift of the other interference from the chirped source 110a is the sum of the doppler shift and the shift due to the FMCW range detection technique FM. Accordingly, this enables to determine range and closing velocity of the target object.

To assure discrimination between the frequencies, and to avoid confusion with the doppler attributed frequency, and the FMCW attributed frequency, the intensities of the two reference arms can be adjusted to be different such that one of them will always be higher, or by adding a basic frequency shift between them.

Similar to above system configurations, the interference between the two reference arms is preferably filtered out, either analogously or digitally, or by having it in a frequency much higher than the photodiode bandwidth.

Accordingly, the present disclosure according to some embodiments, provides a system and corresponding method for detection of range to (distance of) one or more target objects, and/or its velocity. The system may include a light source unit comprising one or more light sources provides one or more electromagnetic beams of selected wavelength and coherence length, one or more beam splitters configured to split the emitted beams forming at least one signal beam directed to the target, and two or more reference beams. The two or more reference beams may have different modulations between them and may be combined to form a reference beam. A collection optical arrangement may be configured for collecting light reflected from the target object and combine the collected light with the reference beam. The combined beam is directed to a detection unit for collecting a sequence of detected instances in a selected sampling rate. The detector unit provides a sequence of detected instances to a processing unit for determining frequency components of the collected signals, enabling detection of distance of the target object in accordance with a relation between selected features of the frequency components, typically associated with frequency peaks at relative frequencies associated with relation between modulation frequencies of the reference beams and that of the signal beam.

Certain known range measurement techniques are based on FMCW (Frequency Modulated Continuous Wave). In this method, the light source is chirped, its frequency is increased/decreased over time, and the frequency difference between the local oscillator and the signal—caused by the time delay of the signal light travelling back and forth to the target—causes an interference in a particular frequency. The collected signal is analyzed, and its measured frequency is used to calculate the range.

Due to doppler shift of moving targets, a complex up-and-down chirp is usually used in conventional technique. This complex chirp solves the doppler ambiguity by adding a second equation, from which the distance and velocity of the target can be calculated:

$$r = c \frac{{f}_{up} + {f}_{down}}{2 γ}$$

$$v = λ \frac{{f}_{up} - {f}_{down}}{4}$$

where c is the speed of light, fᵤₚ+f_{down} are the measured beating frequency in the up and down chirps, A is the wavelength of the source, and y is the chirp rate, i.e.,

$$γ = \frac{B}{T}$$

where B is the bandwidth of the chirp, and T is the total chirp time. This complex chirp dramatically increases the required exposure time needed to perform measurement, thus limiting the potential frame rate of a system.

PCT/IL2021/050340 assigned to the assignee of the present disclosure, and incorporated herein by reference in its entirety, and specifically with respect to detection of range based on coherence variation, describes a Finite Coherence Ranging (FCR) technique (also known as Coherence Time Comparison (CTC)). This technique is generally based on interferometry and utilizes two optical beams and determining a relation between the coherence level of two interferometric measurements to perform range measurement. The two interferometric measurements share the same interrogating beam, and the signal of each measurement is:

$$I = {I}_{r} + {I}_{s} + 2 \sqrt{{I}_{r} {I}_{s}} \cdot cos ( φ ) \cdot {e}^{- \frac{r}{{l}_{c}}}$$

where I_{R}, Iₛ are the intensities of the reference and signal arm correspondingly, φ is the phase difference between the two arms, r is the distance to the target, and l_{c} is the coherence length of the laser source. Subtracting the DC terms Iᵣ+Iₛ from each interferometric measurement, and dividing the two measurements provides a gamma

$$Γ = \frac{2 \sqrt{{I}_{r 1} {I}_{s}} \cdot {e}^{- \frac{r}{{l}_{c 1}}}}{2 \sqrt{{I}_{r 2} {I}_{s}} \cdot {e}^{- \frac{r}{{l}_{c 2}}}} = {e}^{- r ( \frac{1}{{l}_{c 1}} - \frac{1}{{l}_{{c}_{2}}} )}$$

from which the distance to the target can be extracted by:

$$r = - \frac{ln ( Γ )}{( \frac{1}{{l}_{c 1}} - \frac{1}{{l}_{{c}_{2}}} )}$$

However, as there are two interferometric measurements, typical technique may generally require detection of two signals using two detectors. This results, in the same fashion as described above for FMCW, in a more complex system with higher costs. The technique and system of the present disclosure as described herein above solves the requirement of two detectors and enables detection of range and/or velocity of one or more target objects by detection of a temporal interference pattern collected within a single detected signal, e.g., using a single detector operable within a selected sampling rate.

Reference is further made to FIGS. 11 and 12 illustrating further configurations of the optical system 100 according to some embodiments of the present disclosure. FIGS. 11 and 12 exemplify system 100 as illustrated in FIG. 4B, however it should be understood that the configurations exemplified in FIGS. 11 and 12 can be applied in all other system configurations exemplified herein above.

More specifically, FIG. 11 exemplify system 100 utilizing one or more scanners 170 configured to direct output interrogating beam IB toward different selected regions within a selected field of view, and to collect reflected signal beam SB from the respecting selected regions. Scanner 170 may be positioned upstream or downstream to transmission/collection optics 130 (being separated transmission and collection optics or combined as exemplified in FIG. 11). The scanner 170 may be a rotating mirror, MEMS scanner, galvanometric scanner, polygon mirror, voice coil driven mirror, or any other suitable scanner. Scanner 170 can operate with any selected scanning rate while providing sufficient sampling time for each position for collecting data with sufficient frequency bandwidth.

Further, FIG. 12 exemplifies an additional exemplary configuration of system 100 according to some embodiments of the present disclosure. In this example, the system further includes an optical arrangement configured to expand the interrogating beam IB to illuminate a selected field of view. Additionally, the system is configured for collecting reflected signal light SB from the field of view and provide imaging of the field of view onto a detector array, after mixing the collected signal beam with the reference beams. To this end the system includes one or more optical elements 180 configured to adjust divergence of the interrogating beam, and to provide imaging of the collected light (mixed with the reference beam) onto the detector, and utilizes a detector array 142 (e.g., CCD array, linear sensor) having a selected number of pixels, selected in accordance with desired resolution or number of pixels. This configuration enables detection of range to a plurality of positions within the field of view, and effectively enables a three-dimensional mapping of the selected field of view. It should be understood that FIG. 12 exemplifies system 100 utilizing two or more reference beams and using common transmission/collection optics 130. As indicated above, the use of field of view illumination and imaging as exemplified in FIG. 12, may be implemented in various other system configurations as described herein above.

In some other embodiments, optical measurement system may utilize an array including plurality of light sources, each generating a respective beam that is split into signal and reference beams as described above. Signal beam of each light source is directed to cover a selected angular range of a field of view, and collected reflected signal from the respective angular range is interfered with the respective reference beams, providing detected signals as described above. This configuration may further include a scanner providing scan of an entire field of view.

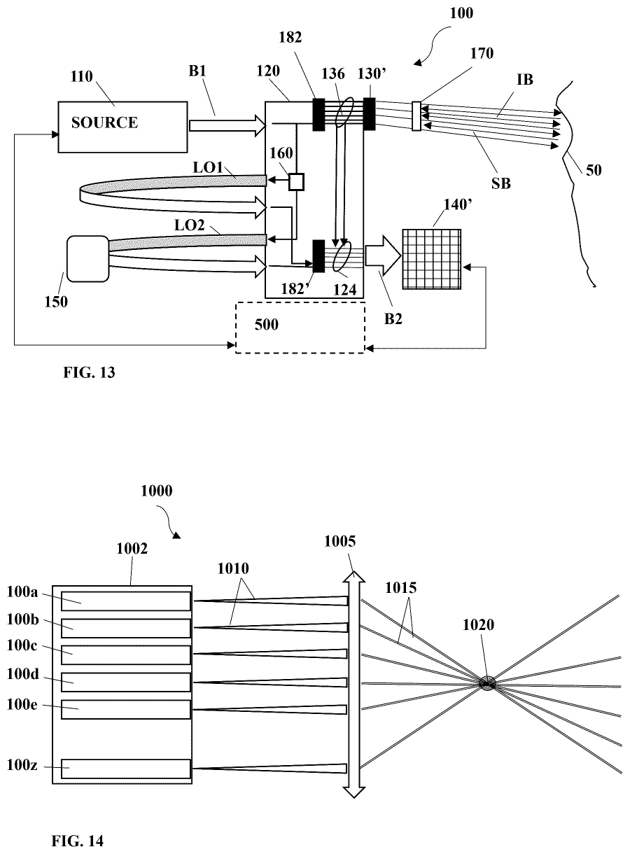

In this connection, reference is made to FIG. 13 exemplifying an additional configuration of optical system 100 according to some embodiments of the present disclosure. System 100 in the example of FIG. 13 includes a light splitting optical element 182, receiving the signal beams and configured to split the signal beams into a plurality of beams. Transmission/collection optics 130′ is configured to receive the plurality of beams and transmit a plurality of interrogating beams IB toward a plurality of locations in a field of view, e.g., covering different points on object 50. Interrogating beams IB may be directed to a selected number of different angular regions of a field of view, thereby enabling monitoring of different angular sections of the field of view. Transmission/collection optics 130′ is further configured to collect a plurality of signal beams SB reflected from the plurality of locations in the field of view back into the system 100.

Additional one or more light splitting optical element 182′ is configured to receive the reference beams LO1 and LO2 and split the reference beams into a similar plurality of reference beams portions. Light splitting optical element 182′ may receive combined input of the reference beams LO1 and LO2. Alternatively, the system may utilize two or more light splitting elements 182′ for each of the two or more reference beams, and respective beam combiners for directing the reference and signal beams to common detector elements. The plurality of the split beam portions, including signal beams and reference beams are interfered separately, to provide a respective interference beam B2 for each location of the field of view in accordance with arrangement of plurality of interrogating beams IB. Further, the different portions of the interference beams B2 are detected by respective detection element, exemplified by arrangement of detectors 140′. Arrangement of detectors 140′ may be a one-dimensional array of detectors, or two-dimensional array, in accordance with spatial arrangement of the split beams when combined in interference beams B2. This configuration utilizes a single light source unit 110 and optical arrangement 120, while providing a plurality of interrogating beams enabling simultaneous detection of range and/or velocity parameters of objects within a field of view. Further, this configuration may be used to provide scanning of a field of view by monitoring regions of the field of view in each scan location using scanner 170.

FIG. 14 illustrates a further configuration of detection system 1000 according to some additional embodiments of the present disclosure. Detection system 1000 includes optical systems array 1002 formed of a plurality of optical systems 100a-100z arranged in a one-dimensional array, optical lens arrangement 1005 and scanner 1020. Each of the optical systems 100a-100z is configured as described above by system 100. In this connection, optical systems 100a-100z may relate to split beam portions are described above with respect to FIG. 13, utilizing common light source and optical arrangement units.

The optical systems 100a-100z may be configured using common or separate transmission/collection optics and may be configured to utilize two or more reference beams and/or two or more interrogating/signal beams. Additionally, optical systems array 1002 may be configured as an optical system on a chip, having a plurality of optical arrangements 100a-100z arranged on a common, or two or more separate, chips, and configured to provide an array of generally parallel output beams 1010.

The array of generally parallel output beams 1010 is transmitted toward optical lens arrangement 1005 positioned and configured to convert lateral location of the beams 1010 to angular directions of the beams, such that each of the beams 1010 covers a selected angular range of a one-dimensional field of view, such that the plurality of optical systems 100a-100z cover a selected one-dimensional field of view.

Detection system 1000 may further include a scanner 1020, e.g., scanning mirror, located generally around focal point of optical lens arrangement 1005. Scanner 1020 is configured to scan along a selected axis, generally perpendicular to an axis defined by arrangement of the optical systems 100a-100z. Thus, the plurality of optical systems 100a-100z cover angular sections along a selected first axis, and scanner 1020 provides scanning along a second, generally perpendicular axis, together covering an entire selected field of view. This configuration provides for relatively fast scanning of a field of view, as compared to two-dimensional scan, e.g., using the system configuration illustrated in FIG. 11, and provides increased range with respect to field illumination, e.g., using the system configuration as illustrated in FIG. 12. In some examples, the system configuration of FIGS. 13 and/or 14 may provide scanning/frame rate of 30 frames per second and may enable detection range of 250 meter or more. It can also provide a scanning rate of 30 scans per second, with a frame rate of 10 frames per second, resulting with 3 scans per system per frame, each with a slightly different vertical position relative to the generally perpendicular scan axis. It can also provide a scanning rate of 10 scans/frames per second, resulting in a higher resolution scan.

Accordingly, the optical system 100 or 1000 may utilize a transmission/collection beam splitting arrangement 182 with or without a lens arrangement 1005, said transmission/collection beam splitting arrangement 182 is configured to split the one or more signal beams to a selected number of interrogating beams 1015 providing data on a plurality of locations on the object 50 or within a field of view. The lens arrangement 1005 when used may be positioned to direct the selected number of beams to cover a selected number of angular regions within a field of view. This configuration may enable detection of range and/or velocity of a plurality of location within a selected field of view. This configuration may further utilize scanning, e.g., using scanner 1020 or 170 to cover a larger field of view.

The present technique, as described above provides for detection of at least one of range and Doppler shift of an object, using detection of one temporal signal, and utilizes frequency analysis of the collected signal. Further, as described above, the present technique can also determine between positive and negative Doppler shifts.

The system of the present disclosure, in its various configurations is described as operating using an interrogating beam directed at a target object. It should be noted that various modifications and improvements may be used as described herein below.

The system may use a scanner to scan a selected region. The scanner unit may utilize MEMS scanner, Galvanometric scanner, polygon mirror, voice coil driven mirror, etc. The scanner may operate to transmit interrogating beam toward different selected positions and collect respective reflected signals from the selected positions.

The single detector 140 may be replaced with a detector array. This may be used in combination with transmission/collection optics that provide imaging of the target object. Broad illumination beam and collection using imaging conditions, and/or selected two-dimensional or one-dimensional scanning, may be used to provide range and/or doppler data for an entire field of view in a common measurement session. Further, as exemplified in FIGS. 13 and 14, the optical system may be configured to provide a plurality of output interrogating beams arranged in a one- or two-dimensional array to provide a detection system 1000, such that the array of optical systems cover one axis of the field of view, and a respective scanner provides for scanning along a second, generally perpendicular axis of the field of view.

Modulators 150 and PM described above and provide phase and/or frequency modulation. Phase modulation may be in the form of temporal phase pattern that may result in reducing or varying coherence length of the beam. Such modulator or phase shifter may be of any type selected in accordance with wavelength of the emitted radiation used. Further, FIGS. 8A, 9A and 10A may be operated with selected number of modulators and not all phase modulators PM are needed.

Further, it should be noted that the present disclosure utilizes two or more reference (signal) beams, where typically one of the two reference (or signal) beams is frequency shifted or modulated, and one of the reference (or signal) beams may have reduced amplitude with respect to the other. It should be noted that each of the reference (signal) beams may be varied, and it matters not which one as long as the selection is pre-known. The signal may be analyzed by determining the described peak pattern, which may have known frequency separation between the peaks and known amplitude ratio.

Lowering the amplitude of one arm in relation to the second arm can be achieved in many ways. For example, the system may utilize a non-symmetric beam splitter, optical attenuator, or any other way.

The frequency shift between the reference (signal) beams may be set to be at a selected value ω⁺ selected in accordance with system configuration. Further, such frequency shift can be realized either by adding all the shift (ω⁺) to one beam, or by splitting it between the two beams, i.e., shifting both beams by different shifts. For example, this splitting can be done by raising the frequency of one reference arm by half of the shift

$$( \frac{{ω}^{+}}{2} )$$

so that its frequency is

$${ω}_{L O 1} = {ω}_{0} + \frac{{ω}^{+}}{2} ,$$

while reducing the frequency of the second reference arm by half of the shift

$$( \frac{{ω}^{+}}{2} )$$

so that its frequency is

$${ω}_{L O 2} = {ω}_{0} - \frac{{ω}^{+}}{2} .$$

In any case, the overall difference between the frequencies of the two reference arms is a known shift ω⁺.

The principle presented in the present disclosure can be implemented in different wavelength regimes including e.g., optical spectrum, infrared, radio frequency, UV, or any other EM radiation, and even in acoustic waves systems. The term optical or light used herein are to be interpreted broadly as relating to electromagnetic radiation. It should however be noted that the present disclosure is advantageous at infrared or high frequencies (visible, UV etc.) where typical detectors are limited in direct sampling of beam frequency ω₀.

It should also be noted that the system of the present disclosure may be implemented in free-space propagation, optical fibers, optical circuit on a chip, planar Lightwave circuit, or any other technique. The frequency shifter may be of any type suitable for the main beam frequency ω₀, for example, the frequency shifter may be: Electro-Optical Modulator, Acousto-Optic Modulator, nonlinear crystal, etc. In some embodiments, the frequency shifter may be implemented by a controller operating on the laser source shifting emission frequency thereof in time and adding delay between corresponding two LO or two signal beams. This may be done by temperature control, current modulation, cavity control etc.

The measured frequency shift from the target may be associated with various effects such as doppler effect, laser frequency modulation allowing range detection, or any other effect. Thus, direction of frequency shifts may be selected to be at any direction, i.e., ω⁺ may be positive or negative. The known selected frequency shift ω⁺ may also vary in accordance with known variation, providing chirped signal or any other frequency modulation, while maintaining known shift allowing proper analysis of the detected signal.

The system of the present disclosure may be implemented using a single lens design. More specifically, a common optical element may be used to output transmitted beam toward the target and to input a collected reflected beam from the target into the system. This configuration simplifies registration and alignment, while it may generate high internal reflections. The present disclosure utilizes selected pattern of frequencies in the detected signal that allows for ignoring such high reflections. It should however be noted that in some configurations, the present technique may be implemented using separate transmission and collection optics in accordance with system design requirements.

The system of the present disclosure may thus be used for various applications including, but not limited to, lidar configuration, various sensing, and metrology applications such as doppler vibrometry, medical application including doppler imaging, optical coherence tomography (OCT) etc.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A system comprising at least one radiation source providing coherent radiation beam of a selected frequency range, an optical arrangement, and a detection unit;
said optical arrangement comprises optical elements forming at least first and second interferometer loops, each comprising a reference arm and a signal arm, signal arms of said at least first and second interferometer loops are configured for directing a signal toward one or more target objects, collecting reflected portion of said signal reflected from said one or more target objects, the optical arrangement further comprises a beam combiner configured to receive the collected reflected portion and reference beams and to combine the received beams to a combined interference beam;
the detection unit comprises at least one detector configured for detection of the combined interference beam;
wherein at least one of said at least first and second interferometer loops comprises a frequency shifter positioned along one of reference or signal arm thereof, thereby generating a selected frequency shift to light propagating therethrough;
wherein one of said at least first and second interferometer loops comprises at least one attenuator configured to attenuate amplitude of light portions by a selected factor, thereby signifying a relation between signal components of said at least first and second interferometer loops; and
wherein said detection unit is configured to generate output data indicative of frequency components of said interference between light propagating in reference and signal arms of said at least first and second interferometer loops, said data indicative of frequency components being indicative of frequency shift generated by said target object.

2. The system of claim 1, wherein said at least first and second interferometer loops are partially overlapping.

3. The system of claim 1, wherein said data indicative of frequency components is indicative of direction and magnitude of frequency shift generated by said target object.

4. The system of claim 1, wherein said frequency shift generated by said target object is associated with a doppler shift.

5. The system of claim 1, configured to provide frequency modulated radiation beam, said frequency shift generated by said target object is associated with range to said target object and its velocity.

6. The system of claim 1, further comprising a controller configured and operable to receive and process detection data from said detection unit, and to utilize data on frequency components of the detection data to determine at least data on closing velocity and/or range of said target object.

7. The system of claim 1, wherein said optical arrangement comprises a combined transmission/collection arrangement for directing signal portions toward said target object and collecting reflected signal portions via a common optical element.

8. The system of claim 1, wherein said optical arrangement comprises a transmission/collection optics configured for directing said one or more signal beams toward a target object and for collecting light reflected from said target object, said transmission/collection arrangement comprises at least one quarter wave plate located in path of signal beam and of reflected light and configured to rotate polarization of reflected light with respect to the signal beam.

9. The system of claim 1, wherein a direction of the frequency shift generated by said target object is determined in accordance with frequency order between first and second frequency components of the combined beam associated with said selected frequency shift and frequency shift applied by said target object in accordance with relative amplitude between them.

10. (canceled)

11. The system of claim 1, wherein said at least first and second interferometer loops comprise at least one transmission/collection arrangement, said at least one transmission/collection arrangement comprises one or more optical elements configured to transmit signal beam toward a selected field of view and provide imaging of the selected field of view for collection of reflected portion of said signal reflected from said one or more target objects.

12. The system of claim 1, further comprising a frequency filter adapted to filter frequency components associated with said selected frequency shift.

13. The system of claim 1, further comprising at least one optical amplifier positioned and configured to amplify intensity of beam portions transmitted toward said one or more target objects.

14. The system of claim 1, further comprising one or more optical amplifiers positioned and configured to amplify intensity of one or more of the reference beams.

15. The system of claim 1, further comprising a scanner configured to direct said signal beam toward one or more target objects covering a selected field of view.

16. The system of claim 1, further comprising a transmission/collection beam splitting arrangement and a lens arrangement, said transmission/collection beam splitting arrangement is configured to split said signal beam to a selected number of interrogating beam portions, and said lens arrangement is positioned to direct said selected number of signal beams to cover a selected number of angular regions within a field of view, thereby enabling detection of frequency shift from a plurality of locations within said field of view.

17. An optical detection system comprising an array of optical systems according to claim 1, configured to emit a plurality of interrogating beams, and lens arrangement and at least one scanner.

18. The optical detection system of claim 17, wherein said lens arrangement is placed and configured to direct each of said plurality of interrogating beams toward a respective angular region along a first axis of a field of view, and wherein said scanner is configured to scan said plurality of interrogating beams along a second, generally perpendicular axis of the field of view.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. A method for determining direction and magnitude of frequency shift in a signal beam, the method comprising:
providing coherent illumination having a selected wavelength range, splitting said coherent illumination to at least three illumination portions comprising at least one signal portion and at least one reference portion propagating along at least one reference arm;
applying a selected frequency shift to at least one of said at least three illumination portions;
attenuating amplitude of one of said at least three illumination portions beams to provide different amplitude of the beams, having a selected predetermined level, being a selected difference or a selected ratio;
directing the at least one signal portion toward a target object, and collecting signal portions reflected back from said target object;
combining said at least three illumination portions to generate a combined beam, detecting intensity of the combined beam and determining frequency components of said combined beam with a selected sampling bandwidth; and
processing said frequency components to determine direction and magnitude of frequency shift applied by said target object on said at least one signal portion.

31. The method of claim 30, wherein determining direction of frequency shift comprises determining frequency order between first and second frequency components of the combined beam associated with said selected frequency shift and frequency shift applied by said target object in accordance with relative amplitude between them.

32. (canceled)

33. A system comprising:
a radiation source unit comprising one or more light sources configured to emit radiation of selected coherence properties;
an optical arrangement configured for directing the emitted radiation along at least two signal beams and one or more reference beams;
transmission/collection arrangement configured for transmitting the at least two signal beams toward one or more targets and collecting a reflected beam;
a beam combiner configured to receive the collected reflected beam and the one or more reference beams and to combine the received reflects beam and the at least one reference beam to a combined interference beam;
a detection unit configured for detecting the combined interference beam and to provide detection data;
a frequency shifting unit positioned along propagation path of one of said at least two signal beams and configured to apply selected frequency shift to light portions in said signal beam; and
at least one attenuator located in path of one of said at least two signal beams to provide predetermined attenuation ratio between said at least two signal beams;
wherein the detection unit is configured to provide output data indicative of frequency components of said combined beam, said frequency components being indicative of direction and magnitude of a frequency shift applied by said one or more targets.
